(19) United States
(12) Patent Application Publication
(10) Pub. No.: US 2025/0365695 A1
(43) Pub. Date: Nov. 27, 2025

(54) POSITIONING CONFIGURATION MANAGEMENT FOR ML TRAINING

(71) Applicant: QUALCOMM Incorporated, San Diego, CA (US)

(72) Inventors: Srinivas YERRAMALLI, San Diego, CA (US); Taesang YOO, San Diego, CA (US); Jay Kumar SUNDARARAJAN, San Diego, CA (US); Alexandros MANOLAKOS, Athens (GR); Mohammed Ali Mohammed HIRALLAH, San Marcos, CA (US)

(21) Appl. No.: 18/873,711

(22) PCT Filed: May 23, 2023
(86) PCT No.: PCT/US2023/023221

§ 371 Date: Dec. 10, 2024

(30) Foreign Application Priority Data
Aug. 3, 2022 (GR) 20220100636

(51) Int. Cl. H04W 64/00; H04L 5/00

(52) U.S. Cl. CPC H04W 64/00; H04L 5/0048

(57) ABSTRACT

Aspects presented herein may improve the efficiency and accuracy for ML training and inference, where entities associated with the ML training/inference may be able to identify whether same/similar sets of configurations are used both in the ML training and the ML inference. In one aspect, a UE receives a configuration for a set of positioning measurements from a network entity, where the configuration includes at least one configuration ID associated with an ML data collection or an ML inference for a set of RSs. The UE performs the set of positioning measurements based on the configuration and the set of RSs. The UE stores at least one parameter for the ML data collection or load a first NN based on the at least one configuration ID.

### CROSS-REFERENCE TO RELATED APPLICATION

This application claims the benefit of Greece Patent Application Serial No. 20220100636, entitled “POSITIONING CONFIGURATION MANAGEMENT FOR ML TRAINING AND INFERENCE” and filed on Aug. 3, 2022, which is expressly incorporated by reference herein in its entirety.

### TECHNICAL FIELD

The present disclosure relates generally to positioning systems, and more particularly, to positioning systems involving machine learning (ML).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives a configuration for a set of positioning measurements from a network entity, where the configuration includes at least one configuration identifier (ID) associated with a machine learning (ML) data collection or an ML inference for a set of reference signals (RSS). The apparatus performs the set of positioning measurements based on the configuration and the set of RSs. The apparatus stores at least one parameter for the ML data collection or load a first neural network (NN) based on the at least one configuration ID.

In an aspect of the disclosure, a method, a computer-readable medium, and an apparatus are provided. The apparatus transmits a configuration for a set of positioning measurements to a UE, where the configuration includes at least one configuration ID associated with an ML data collection or an ML inference for a set of RSs. The apparatus receives at least one parameter for the ML data collection or the ML inference based on the at least one configuration ID.

In an aspect of the disclosure, a method, a computer-readable medium, and an apparatus are provided. The apparatus receives a configuration for a set of positioning measurements from a network entity, where the configuration includes at least one configuration ID associated with an ML data collection or an ML inference for a set of RSs. The apparatus transmits a Tx/Rx configuration to the network entity based on the at least one configuration ID, where the Tx/Rx configuration is associated with a reception for the set of RSs. The apparatus transmits the set of RSs based on the Tx/Rx configuration for the ML data collection or the ML inference.

In an aspect of the disclosure, a method, a computer-readable medium, and an apparatus are provided. The apparatus transmits a configuration for a set of positioning measurements to a UE, where the configuration includes at least one configuration ID associated with an ML data collection or an ML inference for a set of RSs. The apparatus receives a Tx/Rx configuration from the UE based on the at least one configuration ID, where the Tx/Rx configuration is associated with a reception for the set of RSs. The apparatus receives the set of RSs based on the Tx/Rx configuration for the ML data collection or the ML inference.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example architecture of a functional framework associated with a machine learning (ML) model in accordance with various aspects of the present disclosure.

FIG. 6 is a diagram illustrating an example progression of ML architecture in cellular networks over the last few years in accordance with various aspects of the present disclosure.

FIG. 7 is a diagram illustrating an example configuration of assistance data for downlink-time difference of arrival (DL-TDOA) in accordance with various aspects of the present disclosure.

FIG. 8 is diagram illustrating an example downlink positioning reference signal (DL-PRS) assistance data in accordance with various aspects of the present disclosure.

FIG. 9 is diagram illustrating an example DL-PRS assistance data in accordance with various aspects of the present disclosure.

FIG. 10 is a diagram illustrating an example of associating or defining a configuration identifier (ID) covering the overall assistance data in accordance with various aspects of the present disclosure.

FIG. 11 is a diagram illustrating an example configuration ID that includes multiple parts in accordance with various aspects of the present disclosure.

FIG. 12 is a diagram illustrating an example of associating or defining configuration IDs for each frequency layer in accordance with various aspects of the present disclosure.

FIG. 13 is a communication flow illustrating an example of association a configuration ID for ML training and inference to positioning associated with PRS in accordance with various aspects of the present disclosure.

FIG. 14 is a communication flow illustrating an example of association a configuration ID for ML training and inference to positioning associated with SRS in accordance with various aspects of the present disclosure.

FIG. 15 is a flowchart of a method of wireless communication.

FIG. 16 is a flowchart of a method of wireless communication.

FIG. 17 is a diagram illustrating an example of a hardware implementation for an example apparatus and/or network entity.

FIG. 18 is a flowchart of a method of wireless communication.

FIG. 19 is a flowchart of a method of wireless communication.

FIG. 20 is a diagram illustrating an example of a hardware implementation for an example apparatus and/or network entity.

FIG. 21 is a flowchart of a method of wireless communication.

FIG. 22 is a flowchart of a method of wireless communication.

FIG. 23 is a diagram illustrating an example of a hardware implementation for an example apparatus and/or network entity.

FIG. 24 is a flowchart of a method of wireless communication.

FIG. 25 is a flowchart of a method of wireless communication.

FIG. 26 is a diagram illustrating an example of a hardware implementation for an example apparatus and/or network entity.

### DETAILED DESCRIPTION

Aspects presented herein may improve the efficiency and accuracy for ML training and inference, where entities associated with the ML training/inference may be able to identify whether same/similar sets of configurations are used both in the ML training and the ML inference. For example, in one aspect of the present disclosure, a configuration identifier (ID) may be used to define an entire reference signal (RS) of positioning signals in a part of a network (e.g., which may include a base station, a base station, an ML model, etc.). Then, for every configuration that the network uses (e.g., configuration for PRS and/or SRS), the network may assign a unique configuration ID and records both the configuration ID and its associated configuration(s) (e.g., the parameters of the configured PRS and/or SRS) (e.g., as [ID, Config]). For example, a configuration ID may be signaled to or configured for a positioning entity (e.g., a UE, a base station, a location server, etc.) in a positioning configuration (e.g., via assistance data if the positioning entity is a UE) and recorded by the positioning entity along with the dataset used for an ML training. For every positioning configuration, there may be an independent NN trained. Then, during an ML inference, a positioning entity may receive a configuration ID and determine the corresponding NN to load and perform the ML inference. As such, aspects presented herein may improve the ML training/interference for positioning entities as similarly positioning configurations are used for the ML training/interference.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit.

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

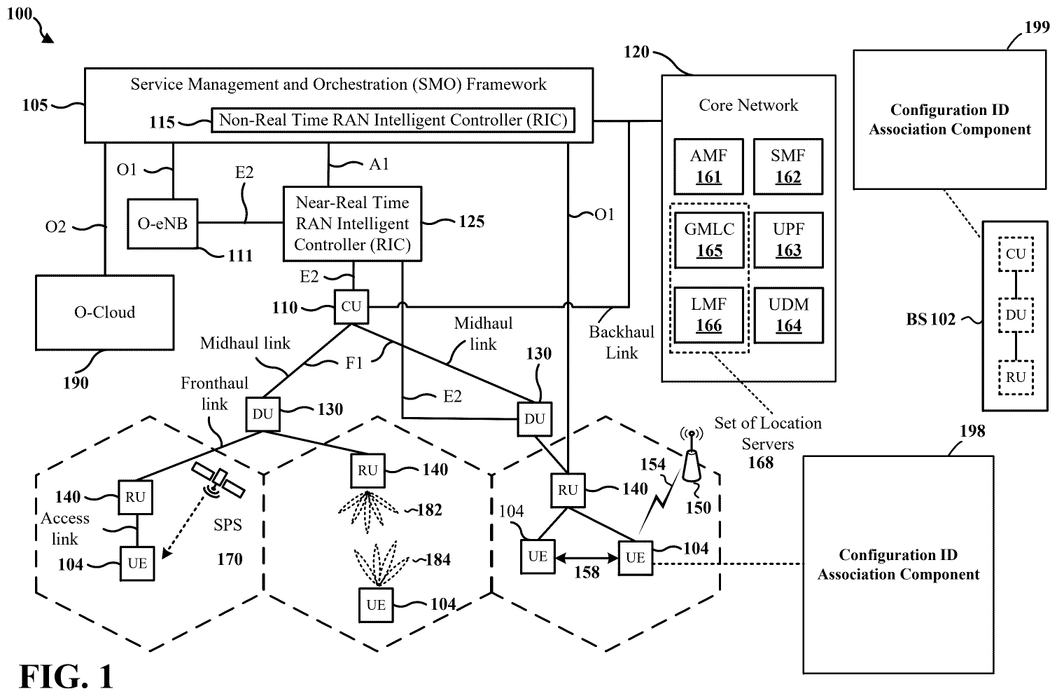

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RA configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to receive a configuration for a set of positioning measurements from a network entity, where the configuration includes at least one configuration ID associated with an ML data collection or an ML inference for a set of RSs; perform the set of positioning measurements based on the configuration and the set of RSs; and store at least one parameter for the ML data collection or load a first NN based on the at least one configuration ID (e.g., via the configuration ID association component 198). In certain aspects, the UE 104 may be configured to receive a configuration for a set of positioning measurements from a network entity, where the configuration includes at least one configuration ID associated with an ML data collection or an ML inference for a set of RSs; transmit a Tx/Rx configuration to the network entity based on the at least one configuration ID, where the Tx/Rx configuration is associated with a reception for the set of RSs; and transmit the set of RSs based on the Tx/Rx configuration for the ML data collection or the ML inference (e.g., via the configuration ID association component 198).

In certain aspects, the base station 102 may be configured to transmit a configuration for a set of positioning measurements to a UE, where the configuration includes at least one configuration ID associated with an ML data collection or an ML inference for a set of RSs; and receive at least one parameter for the ML data collection or the ML inference based on the at least one configuration ID (e.g., via the configuration ID association component 199). In certain aspects, the base station 102 may be configured to transmit a configuration for a set of positioning measurements to a UE, where the configuration includes at least one configuration ID associated with an ML data collection or an ML inference for a set of RSs; receive a Tx/Rx configuration from the UE based on the at least one configuration ID, where the Tx/Rx configuration is associated with a reception for the set of RSs; and receive the set of RSs based on the Tx/Rx configuration for the ML data collection or the ML inference (e.g., via the configuration ID association component 199).

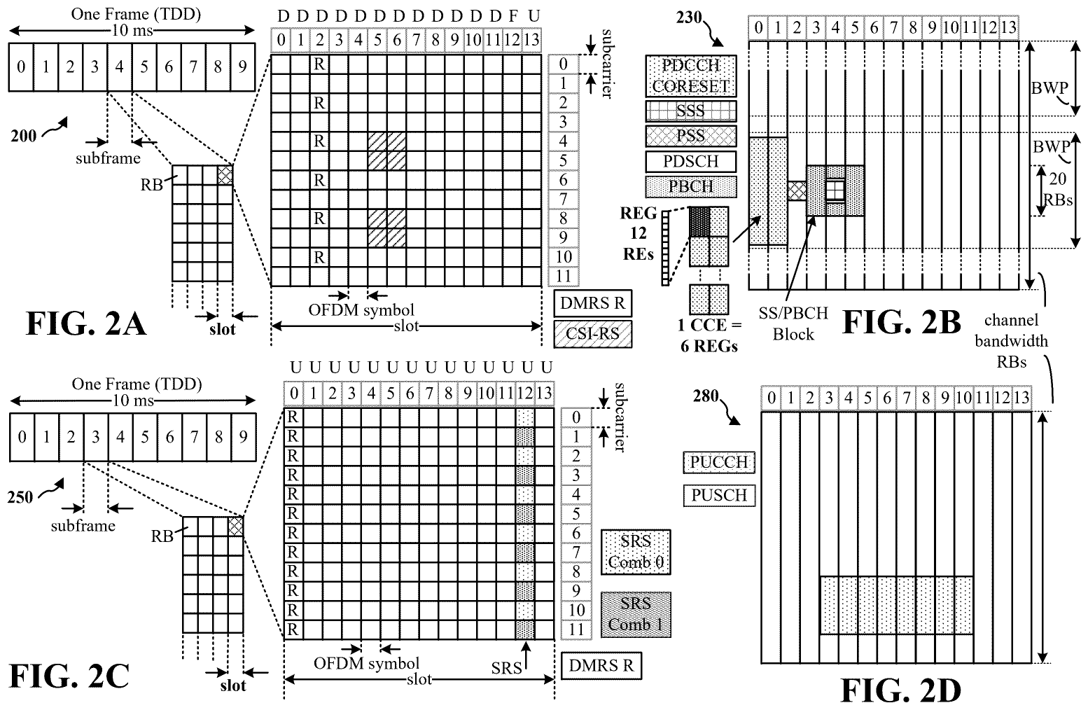

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

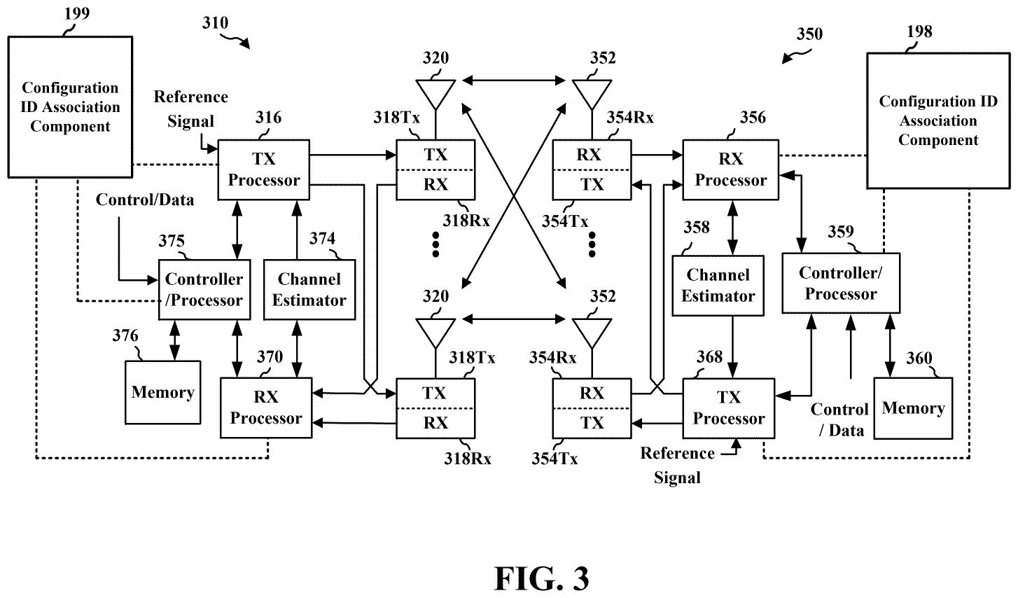

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the configuration ID association component 198 of FIG. 1.

At least one of the TX processor 316, the RX processor 370, and the controller/processor 375 may be configured to perform aspects in connection with the configuration ID association component 199 of FIG. 1.

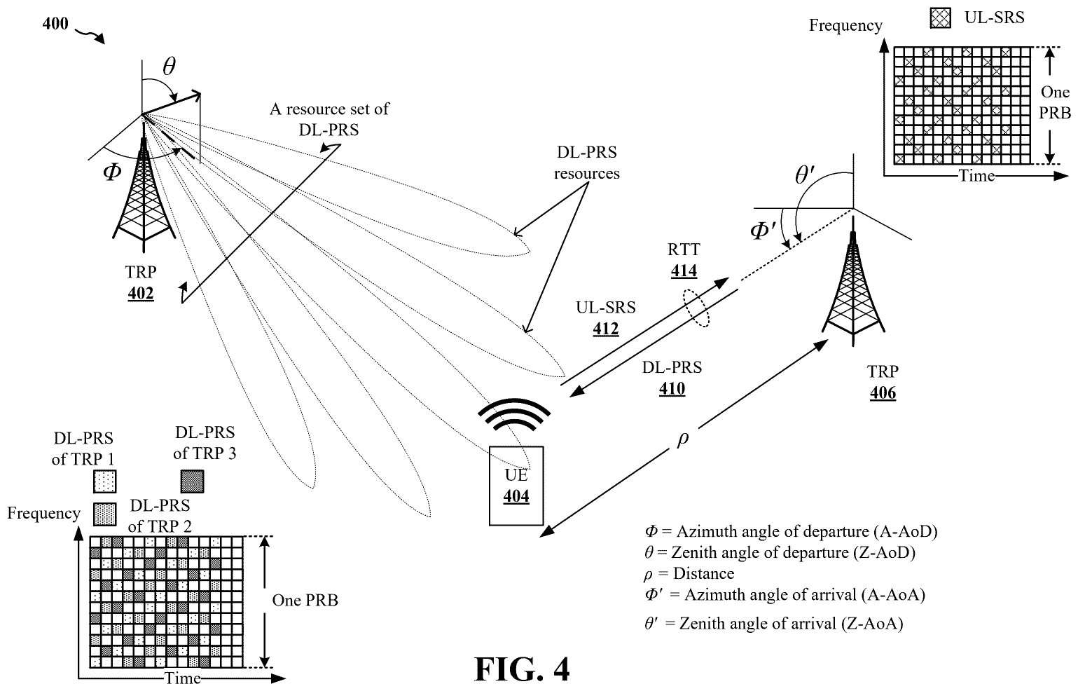

FIG. 4 is a diagram 400 illustrating an example of a UE positioning based on reference signal measurements (which may also be referred to as “network-based positioning”) in accordance with various aspects of the present disclosure. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}| −|T_{SRS_TX}−T_{PRS RX}∥. Accordingly, multi-RTT positioning may make use of the UE Rx-Tx time difference measurements (i.e., |T_{SRS_TX}−T_{PRS RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and/or DL-PRS-RSRP of the received signals) using assistance data received from the positioning server, and the TRPs 402, 406 measure the gNB Rx-Tx time difference measurements (and/or UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using downlink (DL)-time difference of arrival (TDOA) (DL-TDOA) and/or uplink TODA (UL-TDOA) measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL-PRS-RSRP) of downlink signals received from multiple TRPs 402, 406 at the UE 404. The UE 404 measures the DL RSTD (and/or DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL-SRS-RSRP) at multiple TRPs 402, 406 of uplink signals transmitted from UE 404. The TRPs 402, 406 measure the UL-RTOA (and/or UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information. For purposes of the present disclosure, the suffixes “-based” and “-assisted” may refer respectively to the node that is responsible for making the positioning calculation (and which may also provide measurements) and a node that provides measurements (but which may not make the positioning calculation). For example, an operation in which measurements are provided by a UE to a base station/positioning entity to be used in the computation of a position estimate may be described as “UE-assisted,” “UE-assisted positioning,” and/or “UE-assisted position calculation” while an operation in which a UE computes its own position may be described as “UE-based,” “UE-based positioning,” and/or “UE-based position calculation.”

The speed, bandwidth, latency, and reliability of wireless communications (and network-based positioning) have advanced significantly over last few decades, which also increased the complexity of deploying a wireless network in some instances. To improve management of various network nodes and functions, operators and vendors of wireless communication have started to employ artificial intelligence and machine learning (AI/ML) to their services. In one example, AI may be broadly defined as configuring computers/electronics devices to perform tasks regarded as uniquely human. ML may be one category of AI techniques, which include algorithms that are capable of automatically improving their performance without explicit programming.

In some examples, ML algorithms may include supervised learning, unsupervised learning, and/or reinforcement learning. Under the supervised learning, an ML model may specify labelled input and output data during the training phase of the ML. This training data is often labelled by a data scientist in the preparation phase, before being used to train and test the ML model. Once the ML model has learned the relationship between the input and output data, it can be used to classify new and unseen datasets and predict outcomes. Under the unsupervised learning, an ML model may be trained based on raw and unlabeled training data, where the ML model is often used to identify patterns and trends in raw datasets, or to cluster similar data into a specific number of groups. Unsupervised machine learning may be more of a hands-off approach compared to the supervised learning, where the ML model may be configured to process huge arrays of data effectively without human oversight. Under the reinforcement learning, an ML model may be trained based on rewarding suitable behaviors and/or punishing unsuitable behaviors. For example, positive values may be assigned to the suitable actions to encourage the ML model and negative values may be assigned to unsuitable behaviors. This may enable the ML model to seek long-term and maximum overall reward to achieve an optimal solution. ML models are often associated with neural networks (NNs), which may also be known as artificial neural networks (ANNs) or simulated neural networks (SNNs). A neuro network may refer to a computer architecture in which a number of processors are interconnected in a manner suggestive of the connections between neurons in a human brain and which is able to learn by a process of trial and error.

For purposes of the present disclosure, an “inference” or an “ML inference” may refer to a process of running data points into an ML model (e.g., via an inference host) to calculate an output such as a single numerical score, e.g., to use a trained ML algorithm to make a prediction. An “inference host” or an “ML inference host” may refer to a network function which hosts the ML model during an inference mode. On the other hand, a “training” or an “ML training” may refer to a process of running data points to train or teach an ML model (e.g., via a training host). A “training host” or an “ML training host” may refer to a network function which hosts the ML model during a training mode.

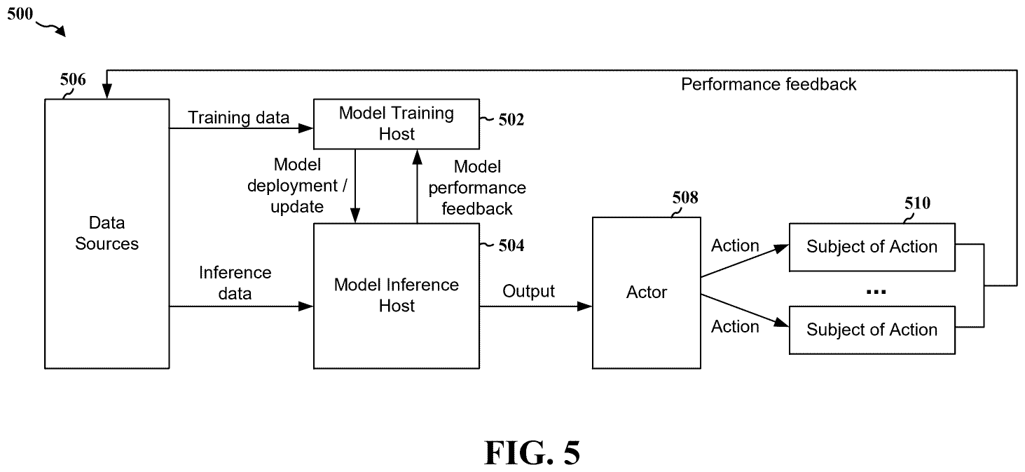

FIG. 5 is a diagram 500 illustrating an example architecture of a functional framework associated with an ML model in accordance with various aspects of the present disclosure. In some scenarios, the functional frame work for an ML model may be enabled by further enhancement of data collection through uses cases and/or examples. In one example, as shown by the diagram 500, a functional framework for the ML model may include multiple logical entities, such as a model training host 502, a model inference host 504, data sources 506, and/or an actor 508, etc. In some examples, multiple logical entities may be co-located on the same device (e.g., a UE, a positioning device, etc.) or a network node (e.g., a base station, a component of the base station, a server, etc.). In other examples, different logical entities may be located at different devices or network nodes.

The model inference host 504 may be configured to run an ML model based on inference data provided by the data sources 506, and the model inference host 504 may produce an output (e.g., a prediction) with the inference data input to the actor 508. The actor 508 may be a device or an entity. For example, the actor 508 may be a GNSS device or a location server associated with the GNSS device, etc. In addition, the actor 508 may also depend on the type of tasks performed by the model inference host 504, type of inference data provided to the model inference host 504, and/or type of output produced by the model inference host 504, etc.

After the actor 508 receives an output from the model inference host 504, the actor 508 may determine whether or how to act based on the output. For example, if the actor 508 is a location server and the output from the model inference host 504 is associated with PR measurement classification, the actor 508 may determine how to classify one or more PR measurements performed based on the output. Then, the actor 508 may indicate the classification to at least one subject of action 510. In some examples, the actor 508 and the at least one subject of action 510 may be the same entity (e.g., the UE).

The data sources 506 may also be configured for collecting data that is used as training data for training the ML model or as inference data for feeding an ML model inference operation. For example, the data sources 506 may collect data from one or more UEs, base stations, or location servers, which may include the subject of action 510, and provide the collected data to the model training host 502 for ML model training. In some examples, if the output provided by the actor 508 is inaccurate (or the accuracy is below an accuracy threshold), the model training host 502 may determine to modify or retrain the ML model used by the model inference host, such as via an ML model deployment/update.

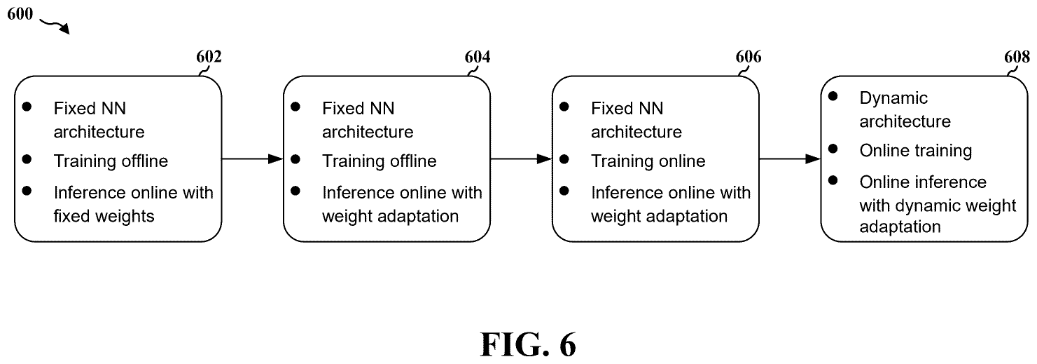

FIG. 6 is a diagram 600 illustrating an example progression of ML architecture (e.g., ML based algorithms) in cellular networks over the last few years in accordance with various aspects of the present disclosure. As shown at 602, initially, ML models employed in cellular networks may include a fixed neuro network (NN) architecture, where everything was trained offline. While the ML inference is performed online, it is based on a fixed rate. Then, as shown at 604, at some later point in time, while the NN architecture remain to be fixed and the initial ML training is still offline, the inference may be performed online with weight adaptation. Thus, an ML model may perform some basic refinement and/or retraining online. As shown at 606, at some later point in time, while the NN architecture remain to be fixed, both the ML training and ML inference may be online, and with weight adaptation for the ML interference. As shown at 608, at a more current point in time, ML models start to employ dynamic NN architecture(s), where both the ML training and ML inference are online, and the ML inference can be performed with dynamic weight adaptation. With more and more ML functions going online and become dynamic, signaling between different entities associated with the ML (e.g., between UEs and a base station or a server) may also increase significantly.

In some examples, for network-based positioning, an NN used in association with a UE positioning (which may be referred to as a positioning NN) may be configured to utilized DL-PRS and UL-SRS to derive the channel, where input to a positioning NN may be derived from the channel. Also, the NN may be trained at one point of time and the inference may happen at a later point of time. In some scenarios, it may be more suitable to have the same DL-PRS and UL-SRS configuration(s) during ML training and ML inference for the optimal results. For example, while some parameter changes in the DL-PRS/UL-SRS configuration(s) may not influence the ML training/inference outcome significantly, it may be important/critical to keep other parameters in the DL-PRS/UL-SRS configuration(s) consistent across the ML training/inference. In some examples, the network and/or the UE may have different NNs trained for different DL-PRS/UL-SRS configurations. Thus, the NNs, the network, and/or the UE may not be able to determine or identify whether same configuration(s) are used both in the ML training and the ML inference, which may affect the accuracy of the ML training/inference.

Aspects presented herein may improve the efficiency and accuracy for ML training and inference, where entities associated with the ML training/inference may be able to identify whether same/similar sets of configurations are used both in the ML training and the ML inference. For example, in one aspect of the present disclosure, a configuration identifier (ID) may be used to define an entire reference signal (RS) of positioning signals in a part of a network (e.g., which may include a base station, a base station, an ML model, etc.). Then, for every configuration that the network uses (e.g., configuration for PRS and/or SRS), the network may assign a unique configuration ID and records both the configuration ID and its associated configuration(s) (e.g., the parameters of the configured PRS and/or SRS) (e.g., as [ID, Config]). For example, a configuration ID may be signaled to or configured for a positioning entity (e.g., a UE, a base station, a location server, etc.) in a positioning configuration (e.g., via assistance data if the positioning entity is a UE) and recorded by the positioning entity along with the dataset used for an ML training. For every positioning configuration, there may be an independent NN trained. Then, during an ML inference, a positioning entity may receive a configuration ID and determine the corresponding NN to load and perform the ML inference. As such, aspects presented herein may improve the ML training/interference for positioning entities as similarly positioning configurations are used for the ML training/interference.

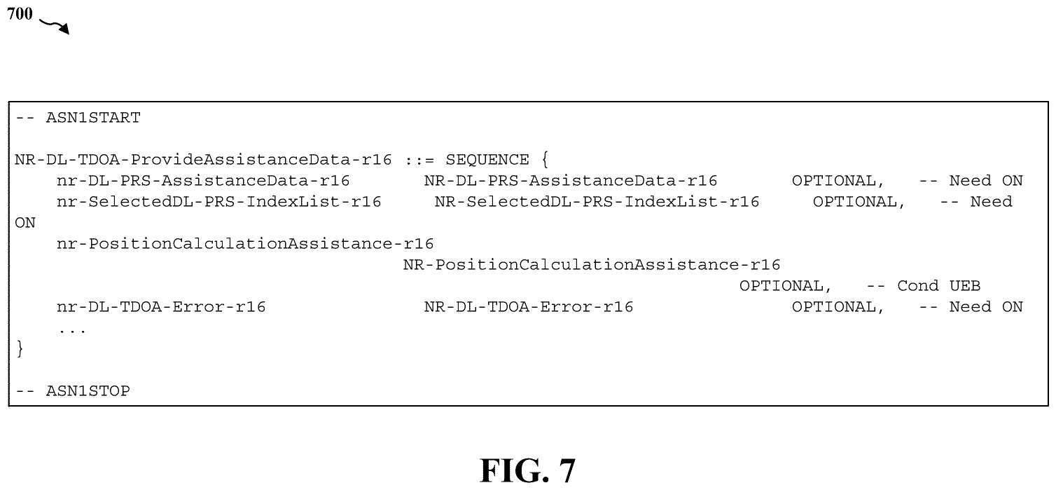

FIG. 7 is a diagram 700 illustrating an example configuration of assistance data for DL-TDOA in accordance with various aspects of the present disclosure. In one example, for each defined positioning method (e.g., DL-TDOA, DL-AOD, UL-TDOA, UL-AOA, etc.), overall assistance data (e.g., NR-DL-TDOA-ProvideAssistanceData) may be defined for the positioning method which may include the DL-PRS assistance data (e.g., nr-DL-PRS-AssistanceData), positioning calculation assistance data (e.g., nr-PositionCalculationAssistance) and/or error event data (e.g., nr-DL-TDOA-Error).

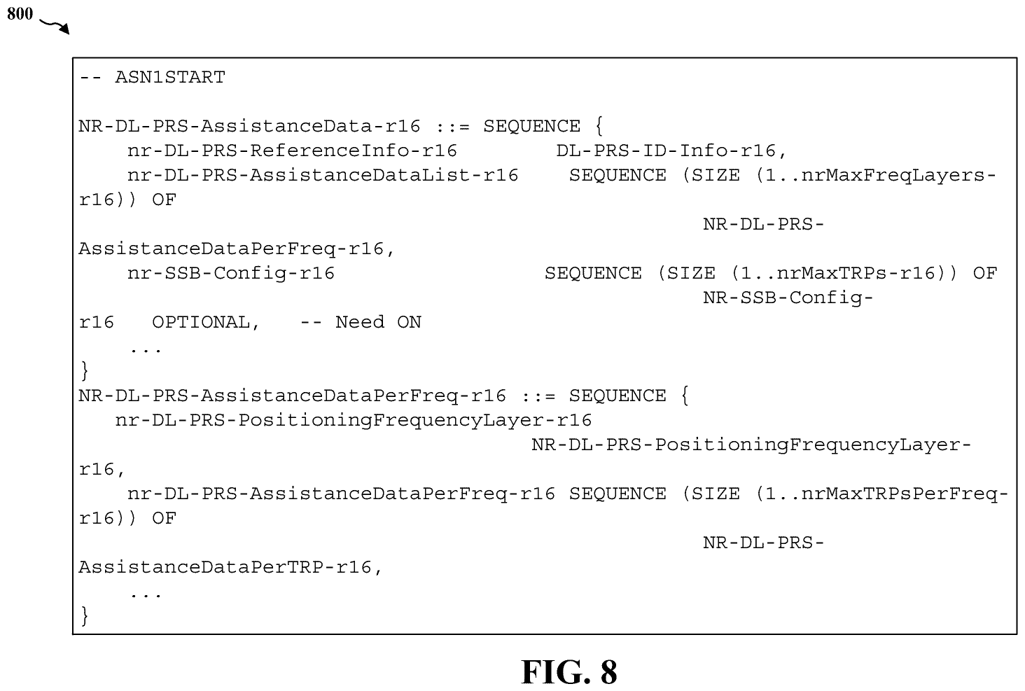

FIG. 8 is diagram 800 illustrating an example DL-PRS assistance data in accordance with various aspects of the present disclosure. In one example, the DL-PRS assistance data may include assistance data for a sequence of TRPs for each frequency layer and definition of each frequency layer.

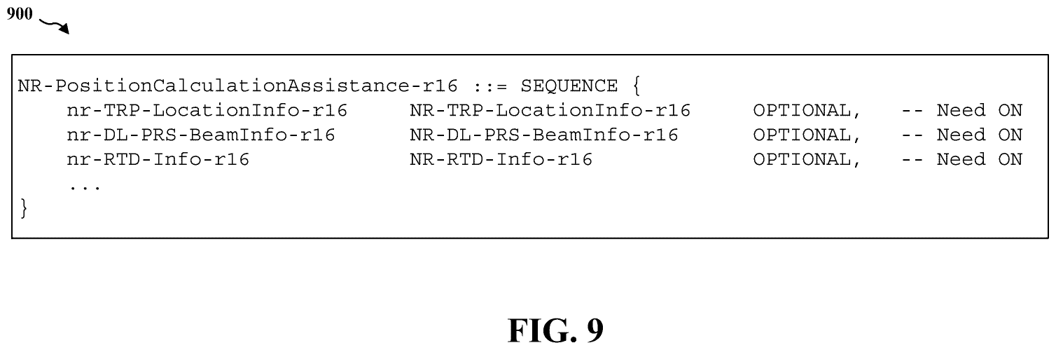

FIG. 9 is diagram 900 illustrating an example DL-PRS assistance data in accordance with various aspects of the present disclosure. In one example, the positioning calculation assistance data may include TRP location information, beam information and/or real time difference (RTD) information, etc.

In one aspect of the present disclosure, during a UE positioning session, one positioning entity (e.g., a UE, a base station, a location server, an LMF, etc.) may indicate to another positioning whether one or more reference signals configured for the UE positioning session are associated with an ML training/inference. For example, a positioning entity (e.g., a base station or a UE) may use a flag (or a specific signaling) to indicate whether a PRS and/or an SRS is used for ML data collection of an ML model. ML data collection may refer to one or more parameters of PRS/SRS being collected as input/training data for an ML model or NN. In addition, the positioning entity may further indicate the ML data collection type, such as whether the ML data collection is for ML training, ML inference, and/or ML refinement. In some examples, the positioning entity may also indicate a priority associated with the ML data collection. For example, a network entity may indicate to a UE in a priority field regarding the priority for the ML data collection. If the priority field indicates a high priority, the ML data collection may take precedence over some other signals (e.g., PDSCH) or processes. In other words, the UE may be configured to drop some of the tasks or signaling if they cannot be performed with the ML data collection at the same time. However, if the priority field indicates a low priority, the UE may be configured to perform the ML data collection as optional, such as when the UE has sufficient resources to do so. The network entity may signal a range of priorities with varying implications on processing other signals

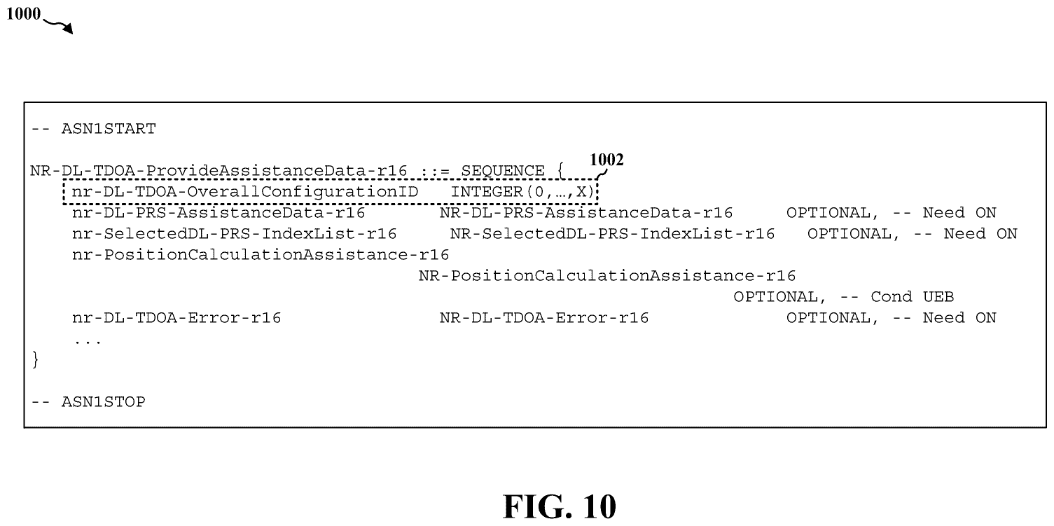

FIG. 10 is a diagram 1000 illustrating an example of associating or defining a configuration ID covering the overall assistance data in accordance with various aspects of the present disclosure. In one aspect, for ML training, it may be more suitable and efficient to have the same TRP locations, antenna configuration(s), and/or per-TRP configuration(s), such that the ML data collected (e.g., positioning related measurements) during the ML training or the UE positioning session may be more consistent. As such, as shown at 1002, a configuration ID may be defined to cover a corresponding overall assistance data. For example, a configuration ID of may be used for a first overall assistance data that is associated with a first set of TRPs, a first set of antenna configuration(s), and a first set of per-TRP configuration(s), and a configuration ID of may be used for a second overall assistance data that is associated with a second set of TRPs, a second set of antenna configuration(s), and a second set of per-TRP configuration(s), etc. As such, when an ML model is performing the ML training or the ML inference, the ML model may be able to determine more accurately whether two sets of ML collection data are based on the same TRP/antenna configuration(s). For example, to optimize the ML training/inference, ML training/inference for a set of UE positioning sessions that is based on the same configuration ID (e.g., have same TRP/antenna configurations) may be given a higher ML training/inference weight as compared to ML training/inference for a set of UE positioning sessions that has different configuration IDs (e.g., have different TRP/antenna configurations).

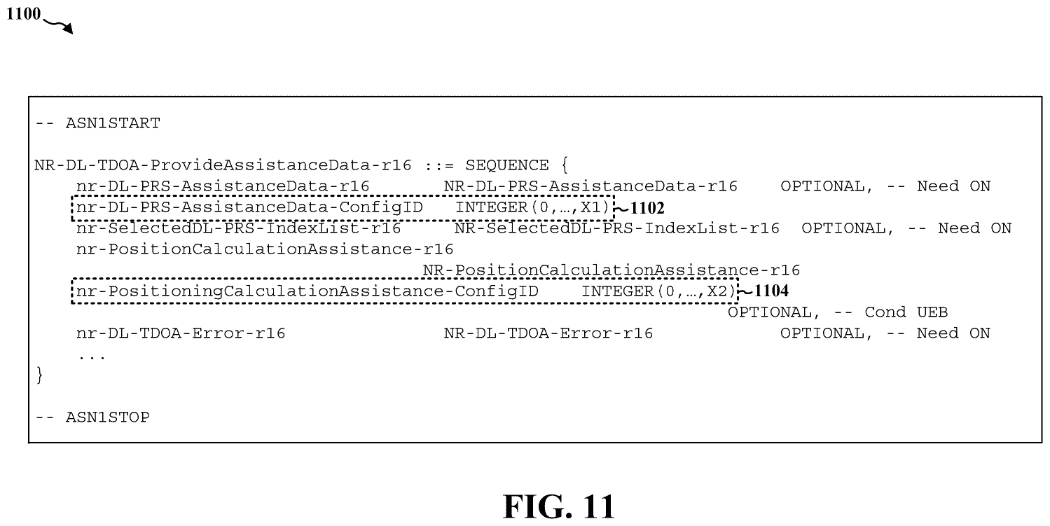

FIG. 11 is a diagram 1100 illustrating an example configuration ID that includes multiple parts in accordance with various aspects of the present disclosure. In another aspect of the present disclosure, instead of or in addition to assigning a configuration ID to overall assistance data, a configuration ID include multiple parts, where different parts may correspond to different parameters in the assistance data.

For example, as shown at 1102 and 1104, a configuration ID in overall assistance data may include a first part (e.g., a first sub ID) that corresponds to the DL-PRS assistance data and a second part (e.g., a second sub ID) that corresponds to the positioning calculation assistance data. As such, DL-PRS assistance data with same parameters/configurations may share the same first sub ID, and positioning calculation assistance data with same parameters/configurations may share the same second sub ID. Table 1 below shows an example configuration ID with two parts. For example, overall assistance data that includes a first set of configurations for DL-PRS assistance data and a first set of configurations for positioning calculation assistance data may be assigned with a configuration ID of [00010001] or [0001, 0001], overall assistance data that includes the first set of configurations for DL-PRS assistance data and a second set of configurations for positioning calculation assistance data (that is different from the first set of configurations for positioning calculation assistance data) may be assigned with a configuration ID of [00010002] or [0001, 0002], and overall assistance data that include a fourth set of configurations for DL-PRS assistance data and the second set of configurations for positioning calculation assistance data may be assigned with a configuration ID of [00040002] or [0004, 0002], etc.

TABLE 1
Example configuration ID with two parts

| Configuration ID | | DL-PRS Assistance | Positioning Calculation |
|---|---|---|---|
| ID Part 1 | ID Part 2 | Data | Assistance Data |
| [0001] | [0001] | Configuration 1 | Configuration 1 |
| [0001] | [0002] | Configuration 1 | Configuration 2 |
| [0002] | [0001] | Configuration 2 | Configuration 1 |
| [0002] | [0002] | Configuration 2 | Configuration 2 |
| [0004] | [0002] | Configuration 4 | Configuration 2 |

By configuring or defining a configuration ID to have multiple parts (e.g., multiple sub IDs), more flexible configuration and signaling may be used by the positioning entities and the ML model. For example, DL-PRS assistance data may have more options/parameters that can be configured compared to the positioning calculation assistance data (e.g., fields in the positioning calculation assistance data may not change very often). Thus, in one example, a positioning entity may indicate a sub-ID to another positioning entity instead of the full configuration ID to reduce the signaling overhead. For example, if configurations for positioning calculation assistance data are the same for a set of UE positioning sessions, the network entity may just indicate the sub-ID corresponding to different configurations of DL-PRS assistance data to UEs participating in the set of UE positioning sessions to reduce signaling overhead. In another example, the multiple sub IDs may also improve the efficiency of ML training/inference by enabling an ML model to focus or identify ML training/inference on a specific part. For example, an ML model may be performing an ML training just related to the positioning calculation assistance data. Thus, the ML model may be configured to focus on the sub-ID corresponding to the positioning calculation assistance data and ignore other sub-IDs. In another example, the ML model may focus on parameters associated with the positioning calculation assistance data and ignore parameters associated with the DL-PRS assistance data, which may greatly reduce the load at the ML model during ML the training/inference.

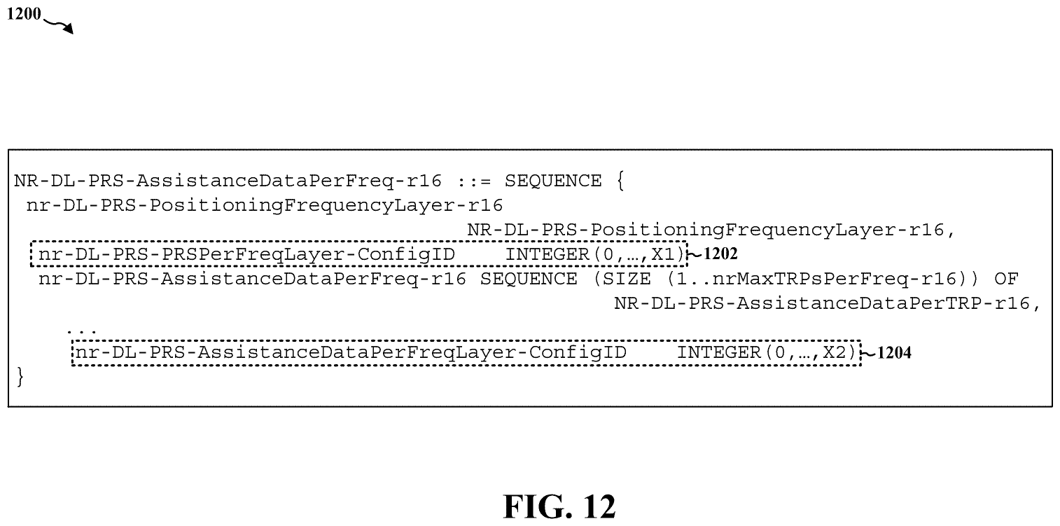

FIG. 12 is a diagram 1200 illustrating an example of associating or defining configuration IDs for each frequency layer in accordance with various aspects of the present disclosure. A positioning frequency layer (PFL) (which may also be referred to as a “frequency layer”) may refer to a collection of one or more PRS resource sets across one or more TRPs that have the same values for certain parameters. Specifically, the collection of PRS resource sets may have a same subcarrier spacing and cyclic prefix (CP) type (e.g., meaning all numerologies supported for PDSCHs are also supported for PRS), the same value of the downlink PRS bandwidth, the same start PRB (and center frequency), and/or the same comb-size, etc. In some examples, a downlink PRS bandwidth may have a granularity of four PRBs, with a minimum of 24 PRBs and a maximum of 272 PRBs. In other examples, up to four frequency layers may be configured, and up to two PRS resource sets may be configured per TRP per frequency layer. In some examples, the concept of a frequency layer may be similar to a CC and a BWP, where CCs and BWPs may be used by one base station (or a macro cell base station and a small cell base station) to transmit data channels, while frequency layers may be used by multiple (e.g., two or more) base stations to transmit PRS. A UE may indicate the number of frequency layers it is capable of supporting when the UE sends the network its positioning capabilities, such as during a positioning protocol session. For example, a UE may indicate whether it is capable of supporting one or four PFLs.

In one example, as shown at 1202 and 1204 configuration IDs may be defined for each frequency layer, such as a first configuration ID (or a first part of a configuration ID) is associated with DL-PRS per frequency layer configuration(s) (e.g., DL-PRS-PRSPerFreqLayer-ConfigID) and a second configuration ID (or a second part of the configuration ID) is associated with DL-PRS assistance data per frequency layer configuration(s) (e.g., DL-PRS-AssistanceDataPerFreqLayer-ConfigID). In some examples, a positioning entity, such as a UE, may use one or more PFLs depending on its capability or network configuration. As such, if the positioning entity uses multiple PFLs to help train the NN, the positioning entity may include the corresponding configuration IDs for the PFLs used to assist the ML model with ML training and inference.

In another aspect of the present disclosure, a configuration ID may be associated with just a subset of parameters in the PRS/SRS configuration. As some parameters in the SRS/PRS configuration may be more important while others may be less important (e.g., from the perspective of ML), a configuration ID may be associated with just the important parameters and/or have multiple ranges or sets of values for less important values.

For example, parameters such as subframe number (SFN), subframe, slot, symbol, tone mapping, and/or changing cell ID, etc., for PRS/SRS may be less important and may be changed without impacting the overall positioning configuration significantly for the purpose of training the NN. For example, PRS/SRS resources may be mapped to a shifted set of time domain resources, which may not impact the overall training for the NN. On the other hand, parameters such as the beam used for transmitting the PRS, the elevation of the beam for transmitting the PRS, the bandwidth of the PRS, and/or the subcarrier spacing (SCS) of the PRS may be more important. As such, the configuration ID may be associated with just these important parameters, and parameters that are less important may have different values for the same configuration ID. Table 2 below provides an example of associating configuration IDs with selected parameters, where different configuration IDs may be assigned to PRS assistance data that has different SCS, bandwidth and/or comb size (e.g., more important parameters), and same configuration ID may be assigned to PRS assistance data that has the same SCS, bandwidth, and comb size but different values for SFN (e.g., a less important parameter).

TABLE 2
Example of associating configuration IDs with selected parameters

| | PRS | PRS | PRS | PRS |
|---|---|---|---|---|
| Configuration ID | SCS | Bandwidth | Comb size | SFN |
| 0001 | Value A | Value B | Value C | Value X |
| 0001 | Value A | Value B | Value C | Value Y |
| 0002 | Value D | Value B | Value C | Value X |
| 0002 | Value D | Value B | Value C | Value Z |
| 0003 | Value A | Value B | Value E | Value Y |

In another aspect of the present disclosure, some parameters associated with a configuration ID may be within a range. For example, instead of assigning a first configuration ID for assistance data that includes a first PRS bandwidth (e.g., 10 MHz) and assigning a second configuration ID for assistance data that includes a second PRS bandwidth (e.g., 12 MHz), a same configuration ID may be assigned for a range of PRS bandwidth (e.g., 10 to 15 MHz). Thus, any PRS bandwidth that falls the range may be assigned with the same configuration ID (assuming other parameters selected also have the same values).

In another aspect of the present disclosure, the configuration ID may further be associated with an area ID to keep the configuration space smaller. For example, a first geographical area may be associated with a first area ID, and a second and different geographical area may be associated with a second area ID. By coupling each configuration ID with an area ID, an ML model may narrow down its training to a more specific area to improve the efficiency of the ML training and inference. For example, if an ML model performs an ML training and inference targeting the first geographical area, the ML model may collect ML data that includes the first area ID, and may exclude ML data that does not include the first area ID.

In another aspect of the present disclosure, different configuration IDs may be independently defined for different positioning method. For example, a first type/format of configuration ID may be defined for DL-AoD positioning, a second type/format of configuration ID may be defined for DL-TDOA positioning, and a third type/format of configuration ID may be defined for UL-TDOA positioning, etc.

In another aspect of the present disclosure, a network entity may also be configured to record SRS reception configuration ID (e.g., set of beams for each TRP) when the network entity is cataloging data in a server.

In another aspect of the present disclosure, for positioning methods involving UL signals, such as the UL-TDOA positioning and UL-AoA positioning, etc., configuration for the UL-SRS may be defined in radio control resource (RRC), where different UEs may have orthogonal SRS configurations. As such, in one aspect, a base station may indicate a UL-SRS configuration ID which may be common for multiple UEs, where such configuration ID may be agnostic to specific resource allocation (ex. comb offset, symbol, slot offset etc.).

In another example, a UE may have a transmission configuration and/or a reception configuration which may be indicated to a network (e.g., in a UE-Transmission-Config-ID and/or UE-Reception-Config ID, etc.). For example, a UE may indicate a first transmission configuration ID to a network which indicates that the UE is transmitting the SRS suing one specific antenna, and the UE may indicate a second transmission configuration ID to the network which indicates that the UE is transmitting based on time-division multiplexing (TDM) using two antennas (e.g., port cycling), and/or the UE may indicate a third transmission configuration ID to a network which indicates that the UE is using some specific beam forming strategy to receive the DL signals and transmit UL signals, etc. In some examples, a configuration ID may be configured to apply to both SRS transmission and PRS reception at the UE. In other examples, a corresponding configuration ID may be configured each of the SRS transmission and PRS transmission (e.g., two types of configuration IDs). In some scenarios, as the transmission/reception strategies/configurations may be different across different UEs, a network (e.g., NN and ML) may also be trained to be robust and flexible to different UE transmission/reception strategies/configurations.

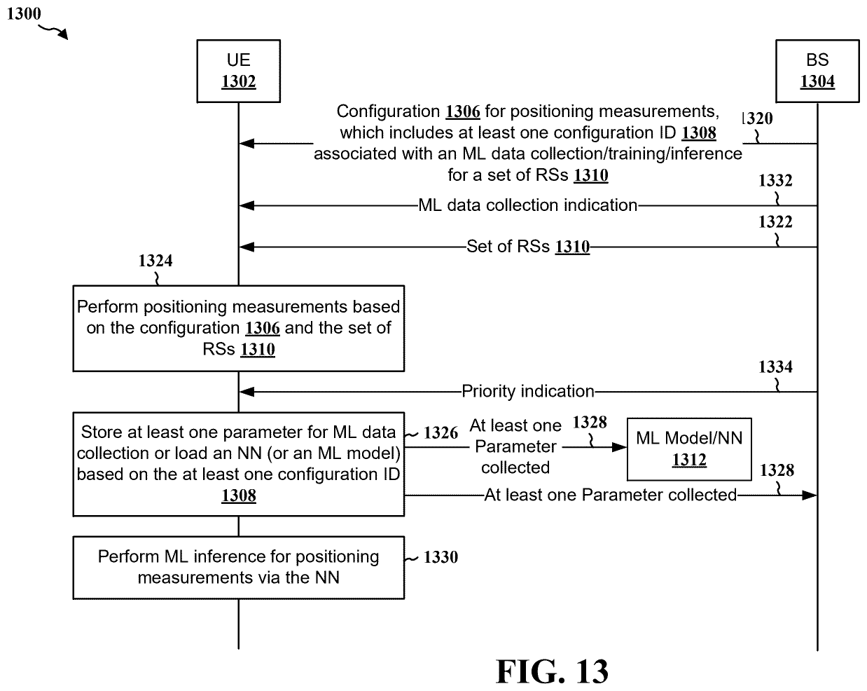

FIG. 13 is a communication flow 1300 illustrating an example of association a configuration ID for ML training and inference to positioning associated with PRS in accordance with various aspects of the present disclosure. The numberings associated with the communication flow 1300 do not specify a particular temporal order and are merely used as references for the communication flow 1300. Aspects presented herein may enable a UE and a network entity (e.g., a base station) to associate configuration IDs with to PRS configurations, which may be used to assist an ML model for ML training, inference, and/or refinement.

At 1320, a UE 1302 may receive a configuration 1306 for positioning measurements from a base station 1304, where the configuration 1306 may include at least one configuration ID 1308 that is associated with an ML data collection, an ML training, an ML inference, and/or an ML retraining/refinement for a set of reference signals (RSs) 1310, such as described in connection with FIGS. 10 to 12. The set of RSs 1310 may include at least one PRS, at least one SSB, at least one CSI-RS, or a combination thereof. The positioning measurements may include measuring DL-AoD, DL-TDOA, and/or RTT associated with DL reference signals, such as described in connection with FIG. 4.

In one example, the at least one configuration ID 1308 may be associated with one or more parameters of overall assistance data configured for a positioning session of the UE 1302, such as described in connection with FIGS. In addition, the overall assistance data may include PRS assistance data, positioning calculation assistance data, error event data, or a combination thereof.

In another example, the at least one configuration ID 1308 may be associated with a frequency layer that is selected based on a capability of the UE 1302.

In another example, the at least one configuration ID 1308 may be associated with a first set of positioning parameters with a fixed value and a second set of positioning parameters with multiple values, such as described in connection with Table 2.

In another example, the at least one configuration ID 1308 may be associated with an area ID.

In another example, the at least one configuration ID 1308 may be associated with a specific positioning mechanism.

At 1322, the base station 1304 may transmit the set of RSs 1310 to the UE 1302 based on the configuration 1306. The set of RSs 1310 may be associated with one or more DL channels, such that the UE 1302 may receive the set of RSs 1310 via one or more DL channels.

At 1324, after receiving the configuration 1306 and the set of RSs 1310, the UE 1302 may perform positioning measurements for the set of RSs 1310 based on the configuration 1306, such as measuring the TDOA, AoA and/or RTT for the set of RSs 1310.

At 1326, the UE 1302 may store at least one parameter for the ML data collection or load a first NN (or a first ML model) based on the at least one configuration ID 1308.

In one example, at 1326, if the UE 1302 is configured to store at least one parameter (e.g., PRS bandwidth, PRS SCS, PRS beam ID, etc.) for the ML data collection based on the at least one configuration ID 1308, the UE 1302 may perform the ML data collection based on the at least one parameter. Then, as shown at 1328, the UE 1302 may transmit the at least one parameter for a ML training procedure, such as to an ML model or NN 1312 that is associated with the ML data collection or to the base station 1304 (e.g., if the ML model/NN is at the base station 1304). In one example, the ML training procedure may be associated with a second NN that is different from the first NN (e.g., the NN for the ML data collection is different from the NN for ML training).

In another example, at 1334, the base station 1304 may transmit a priority indication for the ML data collection to the UE 1302. For example, the priority indication may indicate whether the ML data collection is high priority or low priority. In response, the UE 1302 may determine whether to perform the ML data collection based on the indication. For example, if the priority indication is high, the UE 1302 may be configured to perform the ML data collection and drop some other tasks (e.g., reception of PDSCH) when there is a conflict, whereas if the priority indication is low, the UE 1302 may be configured to perform the ML data collection when it has sufficient resources to do so.

In another example, at 1326, if the UE 1302 is configured to load the first NN based on the at least one configuration ID, then at 1330, the UE 1302 may perform the ML inference for the positioning measurements via the first NN.

In another example, at 1332, the base station 1304 may transmit an indication to the UE 1302 indicating that the set of RSs 1310 is for the ML data collection or for the ML inference. In some examples, the indication may be included in the configuration 1306. In addition, the indication may further indicate a data collection type, such as that the ML data collection is for ML training, ML inference, and/or ML refinement/retraining, etc.

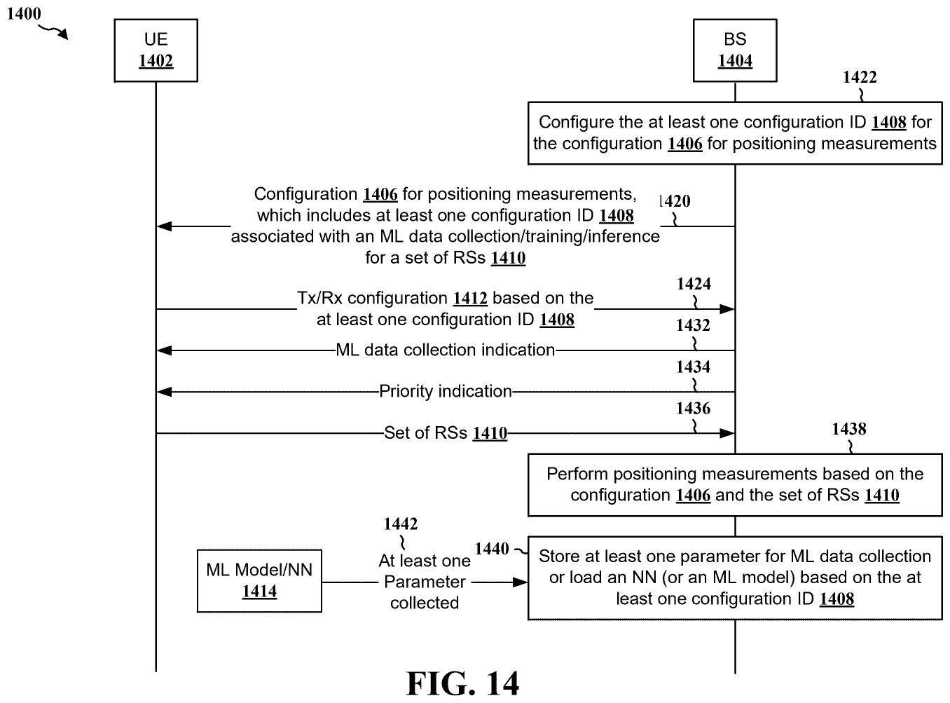

FIG. 14 is a communication flow 1400 illustrating an example of association a configuration ID for ML training and inference to positioning associated with SRS in accordance with various aspects of the present disclosure. The numberings associated with the communication flow 1400 do not specify a particular temporal order and are merely used as references for the communication flow 1400. Aspects presented herein may enable a UE and a network entity (e.g., a base station) to associate configuration IDs with to SRS configurations, which may be used to assist an ML model for ML training, inference, and/or refinement.

At 1420, a UE 1402 may receive a configuration 1406 for positioning measurements from a base station 1404, where the configuration 1406 may include at least one configuration ID 1408 that is associated with an ML data collection, an ML training, an ML inference, and/or an ML retraining/refinement for a set of reference signals (RSs) 1410, such as described in connection with FIGS. 10 to 12. The set of RSs 1410 may be SRSs. The UE 1402 may receive the configuration 1406 via RRC signaling/messaging. The positioning measurements may include measuring UL-AoA, UL-TDOA, and/or RTT associated with UL reference signals, such as described in connection with FIG. 4.

In one example, the configuration 1406 may apply to a plurality of UEs. In another example, the configuration 1406 may be associated with a specific resource allocation.

In another example, the at least one configuration ID 1408 may be associated with a frequency layer that is selected based on a capability of the UE 1402.

In another example, the at least one configuration ID 1408 may be associated with a first set of positioning parameters with a fixed value and a second set of positioning parameters with multiple values, such as described in connection with Table 2.

In another example, the at least one configuration ID 1408 may be associated with an area ID.

In another example, the at least one configuration ID 1408 may be associated with a specific positioning mechanism.

In another example, as shown at 1422, prior to transmitting the configuration 1406, the base station 1422 may configure the at least one configuration ID 1408 for the configuration 1406.

At 1424, the UE 1402 may transmit a transmission or reception (Tx/Rx) configuration to the network entity based on the at least one configuration ID, where the Tx/Rx configuration is associated with a reception or a transmission for the set of RSs 1410. In one example, the Tx/Rx configuration indicates: at least one antenna used by the UE 1402 for transmitting the set of RSs 1410, the UE 1402 is transmitting the set of RSs 1410 based on TDM using at least two antennas, and/or a beamforming strategy for transmitting the set of RSs 1410, etc.

In another example, at 1432, the base station 1404 may transmit an indication to the UE 1402 indicating that the set of RSs 1410 is for the ML data collection or for the ML inference. In some examples, the indication may be included in the configuration 1406. In addition, the indication may further indicate a data collection type, such as that the ML data collection is for ML training, ML inference, and/or ML refinement/retraining, etc.

In another example, at 1434, the base station 1404 may transmit a priority indication for the ML data collection to the UE 1402. For example, the priority indication may indicate whether the ML data collection is high priority or low priority. In response, the UE 1402 may determine whether to perform the ML data collection based on the indication. For example, if the priority indication is high, the UE 1402 may be configured to perform the ML data collection and drop some other tasks (e.g., reception of PDSCH) when there is a conflict, whereas if the priority indication is low, the UE 1402 may be configured to perform the ML data collection when it has sufficient resources to do so.

At 1436, the UE 1402 may transmit the set of RSs based 1410 on the Tx/Rx configuration for the ML data collection and/or the ML inference.

At 1438, after transmitting the configuration 1406 and receiving the set of RSs 1410, the base station 1404 may perform positioning measurements for the set of RSs 1410 based on the configuration 1406, such as measuring the TDOA, AoA and/or RTT for the set of RSs 1410.

At 1440, the base station 1404 may store at least one parameter for the ML data collection or load a first NN (or a first ML model) based on the at least one configuration ID 1408.

In one example, at 1440, if the base station 1404 is configured to store at least one parameter (e.g., SRS bandwidth, SRS SCS, SRS beam ID, etc.) for the ML data collection based on the at least one configuration ID 1408, the base station 1404 may perform the ML data collection based on the at least one parameter. Then, as shown at 1442, the base station 1404 may transmit the at least one parameter for a ML training procedure, such as to an ML model or NN 1414 that is associated with the ML data collection. In one example, the ML training procedure may be associated with a second NN that is different from the first NN (e.g., the NN for the ML data collection is different from the NN for ML training).

In another example, at 1440, if the base station 1404 is configured to load the first NN based on the at least one configuration ID, then the base station 1404 may perform the ML inference for the positioning measurements via the first NN.

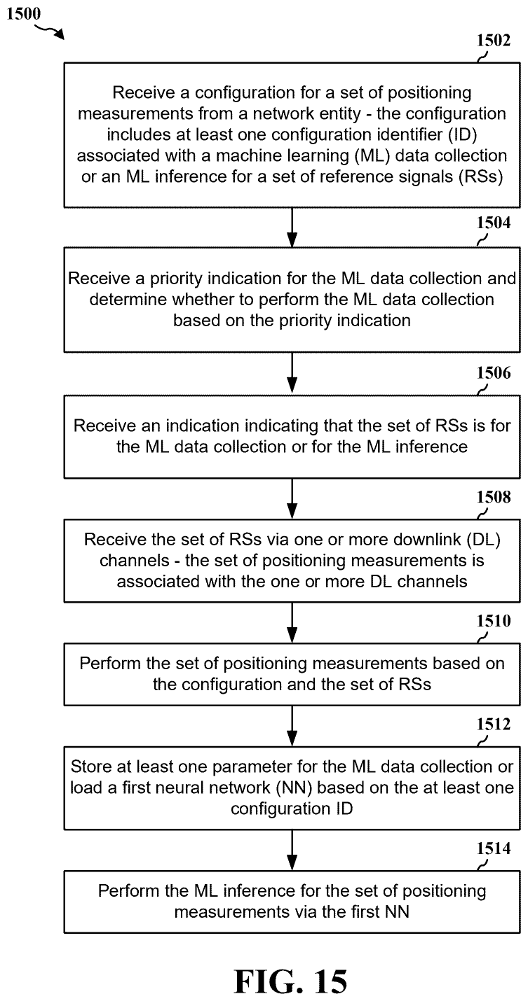

FIG. 15 is a flowchart 1500 of a method of wireless communication. The method may be performed by a UE (e.g., the UE 104, 404, 1302, 1402; the apparatus 1704). The method may enable the UE to associate positioning configurations and measurements with configuration ID to assist an ML model with ML training, inferencing, and/or refinement.

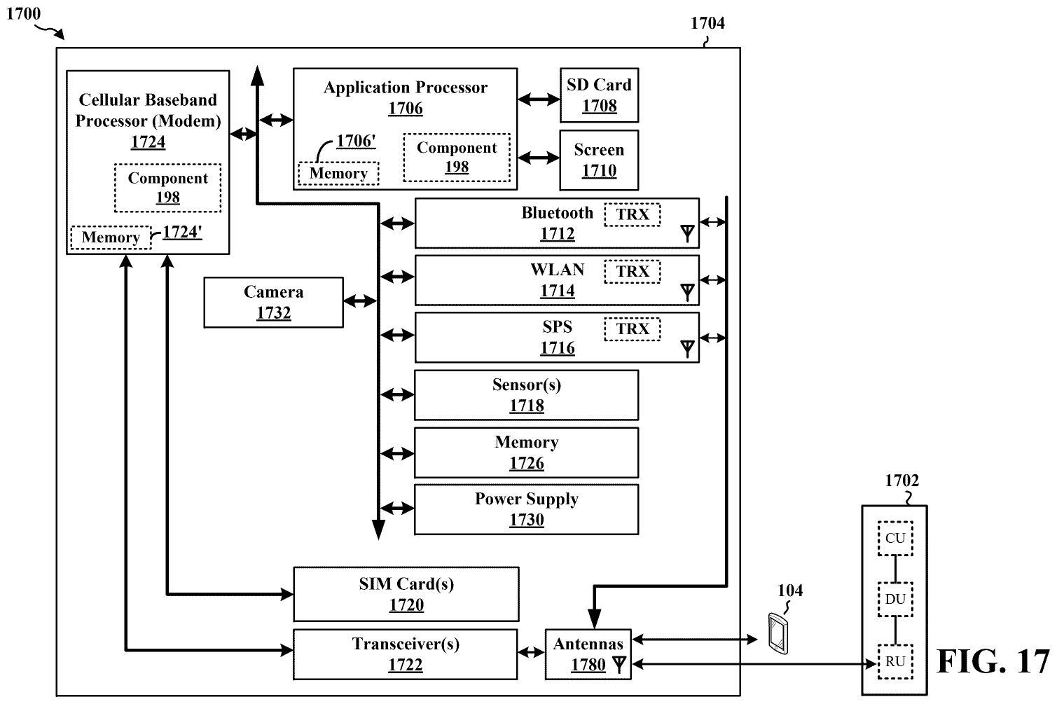

At 1502, the UE may receive a configuration for a set of positioning measurements from a network entity, where the configuration includes at least one configuration ID associated with an ML data collection or an ML inference for a set of RSs, such as described in connection with FIG. 13. For example, at 1320, the UE 1302 may receive a configuration 1306 for positioning measurements from the base station 1304, where the configuration 1306 includes at least one configuration ID 1308 that is associated with an ML data collection/training/inference for a set of RSs 1310. The reception of the configuration may be performed by, e.g., the configuration ID association component 198, the cellular baseband processor 1724, and/or the transceiver(s) 1722 of the apparatus 1704 in FIG. 17.

In one example, the at least one configuration ID is associated with one or more parameters of assistance data configured for a positioning session of the UE, and the assistance data includes at least one of PRS assistance data, positioning calculation assistance data, error event data, or a combination thereof.

In another example, the at least one configuration ID is associated with a frequency layer that is selected based on a capability of the UE.

In another example, the at least one configuration ID is associated with a first set of positioning parameters with a fixed value and a second set of positioning parameters with multiple values.

In another example, the at least one configuration ID is associated with an area ID.

In another example, the at least one configuration ID is associated with a specific positioning mechanism.

In another example, the set of RSs includes at least one PRS, at least one SSB, at least one CSI-RS, or a combination thereof.

At 1504, the UE may receive a priority indication for the ML data collection and determine whether to perform the ML data collection based on the priority indication, such as described in connection with FIG. 13. For example, at 1334, the UE 1302 may receive a priority indication for the ML data collection from the base station 1304 and determine whether to perform the ML data collection based on the priority indication. The reception of the priority indication may be performed by, e.g., the configuration ID association component 198, the cellular baseband processor 1724, and/or the transceiver(s) 1722 of the apparatus 1704 in FIG. 17.

At 1506, the UE may receive an indication indicating that the set of RSs is for the ML data collection or for the ML inference, such as described in connection with FIG. 13. For example, at 1332, the UE 1302 may receive an ML data collection indication indicating from the base station 1304 indicating that the set of RSs 1310 is for the ML data collection or for the ML inference. The reception of the indication may be performed by, e.g., the configuration ID association component 198, the cellular baseband processor 1724, and/or the transceiver(s) 1722 of the apparatus 1704 in FIG. 17.

In one example, the indication further indicates a data collection type.

At 1508, the UE may receive the set of RSs via one or more DL channels, where the set of positioning measurements is associated with the one or more DL channels, such as described in connection with FIG. 13. For example, at 1322, the UE 1302 may receive the set of RSs 1310 from the base station 1304. The reception of the set of RSs may be performed by, e.g., the configuration ID association component 198, the cellular baseband processor 1724, and/or the transceiver(s) 1722 of the apparatus 1704 in FIG. 17.

At 1510, the UE may perform the set of positioning measurements based on the configuration and the set of RSs, such as described in connection with FIG. 13. For example, at 1324, the UE 1302 may perform positioning measurements based on the configuration 1306 and the set of RSs 1310. The positioning measurements may be performed by, e.g., the configuration ID association component 198, the cellular baseband processor 1724, and/or the transceiver(s) 1722 of the apparatus 1704 in FIG. 17.

At 1512, the UE may store at least one parameter for the ML data collection or load a first NN based on the at least one configuration ID, such as described in connection with FIG. 13. For example, at 1326, the UE 1302 may store at least one parameter for the ML data collection or load a first NN based on the at least one configuration ID 1308. The storing of the at least one parameter for the ML data collection and/or the loading of the first NN may be performed by, e.g., the configuration ID association component 198, the cellular baseband processor 1724, and/or the transceiver(s) 1722 of the apparatus 1704 in FIG. 17.

In one example, the UE may store the at least one parameter for the ML data collection based on the at least one configuration ID. In such an example, the UE may perform the ML data collection based on the at least one parameter. In another example, the UE may transmit the at least one parameter for a ML training procedure, where the ML training procedure is associated with a second NN that is different from the first NN.

In another example, the UE may load the first NN based on the at least one configuration ID. In such an example, at 1514, the UE may perform the ML inference for the set of positioning measurements via the first NN, such as described in connection with FIG. 13. For example, at 1330, the UE 1302 may perform the ML inference for positioning measurements via the first NN. The ML inference may be performed by, e.g., the configuration ID association component 198, the cellular baseband processor 1724, and/or the transceiver(s) 1722 of the apparatus 1704 in FIG. 17.

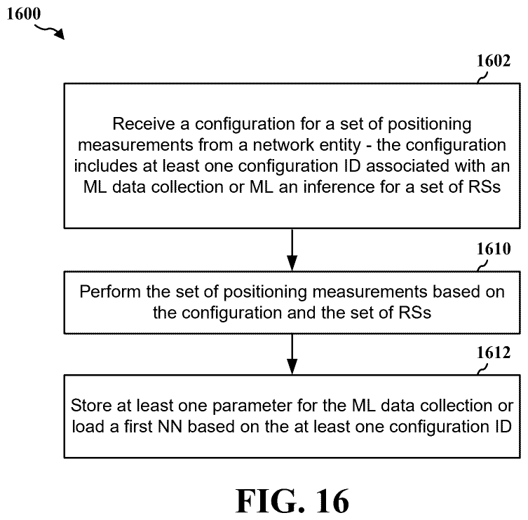

FIG. 16 is a flowchart 1600 of a method of wireless communication. The method may be performed by a UE (e.g., the UE 104, 404, 1302, 1402; the apparatus 1704). The method may enable the UE to associate positioning configurations and measurements with configuration ID to assist an ML model with ML training, inferencing, and/or refinement.

At 1602, the UE may receive a configuration for a set of positioning measurements from a network entity, where the configuration includes at least one configuration ID associated with ML data collection or ML inference for a set of RSs, such as described in connection with FIG. 13. For example, at 1320, the UE 1302 may receive a configuration 1306 for positioning measurements from the base station 1304, where the configuration 1306 includes at least one configuration ID 1308 that is associated with an ML data collection/training/inference for a set of RSs 1310. The reception of the configuration may be performed by, e.g., the configuration ID association component 198, the cellular baseband processor 1724, and/or the transceiver(s) 1722 of the apparatus 1704 in FIG. 17.

In one example, the at least one configuration ID is associated with one or more parameters of assistance data configured for a positioning session of the UE, and the assistance data includes at least one of PRS assistance data, positioning calculation assistance data, error event data, or a combination thereof.

In another example, the at least one configuration ID is associated with a frequency layer that is selected based on a capability of the UE.

In another example, the at least one configuration ID is associated with a first set of positioning parameters with a fixed value and a second set of positioning parameters with multiple values.

In another example, the at least one configuration ID is associated with an area ID.

In another example, the at least one configuration ID is associated with a specific positioning mechanism.

In another example, the set of RSs includes at least one PRS, at least one SSB, at least one CSI-RS, or a combination thereof.

In another example, the UE may receive a priority indication for the ML data collection and determine whether to perform the ML data collection based on the priority indication, such as described in connection with FIG. 13. For example, at 1334, the UE 1302 may receive a priority indication for the ML data collection from the base station 1304 and determine whether to perform the ML data collection based on the priority indication. The reception of the priority indication may be performed by, e.g., the configuration ID association component 198, the cellular baseband processor 1724, and/or the transceiver(s) 1722 of the apparatus 1704 in FIG. 17.

In another example, the UE may receive an indication indicating that the set of RSs is for the ML data collection or for the ML inference, such as described in connection with FIG. 13. For example, at 1332, the UE 1302 may receive an ML data collection indication indicating from the base station 1304 indicating that the set of RSs 1310 is for the ML data collection or for the ML inference. The reception of the indication may be performed by, e.g., the configuration ID association component 198, the cellular baseband processor 1724, and/or the transceiver(s) 1722 of the apparatus 1704 in FIG. 17.

In another example, the indication further indicates a data collection type.

In another example, the UE may receive the set of RSs via one or more DL channels, where the set of positioning measurements is associated with the one or more DL channels, such as described in connection with FIG. 13. For example, at 1322, the UE 1302 may receive the set of RSs 1310 from the base station 1304. The reception of the set of RSs may be performed by, e.g., the configuration ID association component 198, the cellular baseband processor 1724, and/or the transceiver(s) 1722 of the apparatus 1704 in FIG. 17.

At 1610, the UE may perform the set of positioning measurements based on the configuration and the set of RSs, such as described in connection with FIG. 13. For example, at 1324, the UE 1302 may perform positioning measurements based on the configuration 1306 and the set of RSs 1310. The positioning measurements may be performed by, e.g., the configuration ID association component 198, the cellular baseband processor 1724, and/or the transceiver(s) 1722 of the apparatus 1704 in FIG. 17.

At 1612, the UE may store at least one parameter for the ML data collection or load a first NN based on the at least one configuration ID, such as described in connection with FIG. 13. For example, at 1326, the UE 1302 may store at least one parameter for the ML data collection or load a first NN based on the at least one configuration ID 1308. The storing of the at least one parameter for the ML data collection and/or the loading of the first NN may be performed by, e.g., the configuration ID association component 198, the cellular baseband processor 1724, and/or the transceiver(s) 1722 of the apparatus 1704 in FIG. 17.

In one example, the UE may store the at least one parameter for the ML data collection based on the at least one configuration ID. In such an example, the UE may perform the ML data collection based on the at least one parameter. In another example, the UE may transmit the at least one parameter for a ML training procedure, where the ML training procedure is associated with a second NN that is different from the first NN.

In another example, the UE may load the first NN based on the at least one configuration ID. In such an example, at 1614, the UE may perform the ML inference for the set of positioning measurements via the first NN, such as described in connection with FIG. 13. For example, at 1330, the UE 1302 may perform the ML inference for positioning measurements via the first NN. The ML inference may be performed by, e.g., the configuration ID association component 198, the cellular baseband processor 1724, and/or the transceiver(s) 1722 of the apparatus 1704 in FIG. 17.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial management unit (IMU), gyroscope, and/or accelerometer(s), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see 350 of FIG. 3) and include the additional modules of the apparatus 1704.

As discussed supra, the configuration ID association component 198 may be configured to receive a configuration for a set of positioning measurements from a network entity, where the configuration includes at least one configuration ID associated with an ML data collection or an ML inference for a set of RSs. The configuration ID association component 198 may also be configured to perform the set of positioning measurements based on the configuration and the set of RSs. The configuration ID association component 198 may also be configured to store at least one parameter for the ML data collection or load a first NN based on the at least one configuration ID. The configuration ID association component 198 may be within the cellular baseband processor 1724, the application processor 1706, or both the cellular baseband processor 1724 and the application processor 1706. The configuration ID association component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, may include means for receiving a configuration for a set of positioning measurements from a network entity, where the configuration includes at least one configuration ID associated with an ML data collection or an ML inference for a set of RSs. The apparatus 1704 may further include means for performing the set of positioning measurements based on the configuration and the set of RSs. The apparatus 1704 may further include means for storing at least one parameter for the ML data collection or load a first NN based on the at least one configuration ID.

In one configuration, the apparatus 1704 may further include means for receiving a configuration for the set of RSs based on the association between the set of RSs and the one or more CGs, and where the set of RSs is transmitted based on the configuration.

In another configuration, the apparatus 1704 may further include means for receiving the set of RSs via one or more DL channels, where the set of positioning measurements is associated with the one or more DL channels

In another configuration, the apparatus 1704 may further include means for performing the ML data collection based on the at least one parameter.

In another configuration, the apparatus 1704 may further include means for transmitting the at least one parameter for a ML training procedure. In such a configuration, the ML training procedure is associated with a second NN that is different from the first NN.

In another configuration, the apparatus 1704 may further include means for receiving a priority indication for the ML data collection, and means for determining whether to perform the ML data collection based on the priority indication.

In another configuration, the apparatus 1704 may further include means for performing the ML inference for the set of positioning measurements via the first NN.

In another configuration, the apparatus 1704 may further include means for receiving an indication indicating that the set of RSs is for the ML data collection or for the ML inference. In such a configuration, the indication further indicates a data collection type.

In another configuration, the at least one configuration ID is associated with one or more parameters of assistance data configured for a positioning session of the UE, and the assistance data includes at least one of PRS assistance data, positioning calculation assistance data, error event data, or a combination thereof.

In another configuration, the at least one configuration ID is associated with a frequency layer that is selected based on a capability of the UE.

In another configuration, the at least one configuration ID is associated with a first set of positioning parameters with a fixed value and a second set of positioning parameters with multiple values.

In another configuration, the at least one configuration ID is associated with an area ID.

In another configuration, the at least one configuration ID is associated with a specific positioning mechanism.

In another configuration, the set of RSs includes at least one PRS, at least one SSB, at least one CSI-RS, or a combination thereof.

The means may be the configuration ID association component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

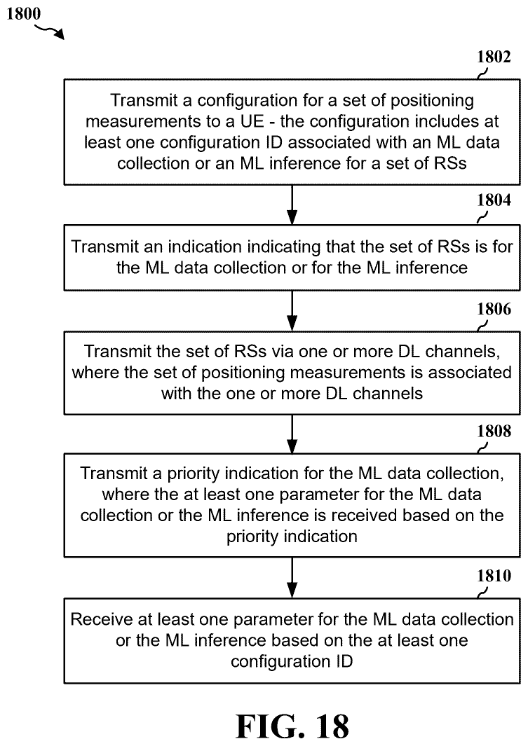

FIG. 18 is a flowchart 1800 of a method of wireless communication. The method may be performed by a base station (e.g., the base station 102, 1304, 1404; the network entity 2002. The method may enable the base station to associate positioning configurations and measurements with configuration ID to assist an ML model with ML training, inferencing, and/or refinement.

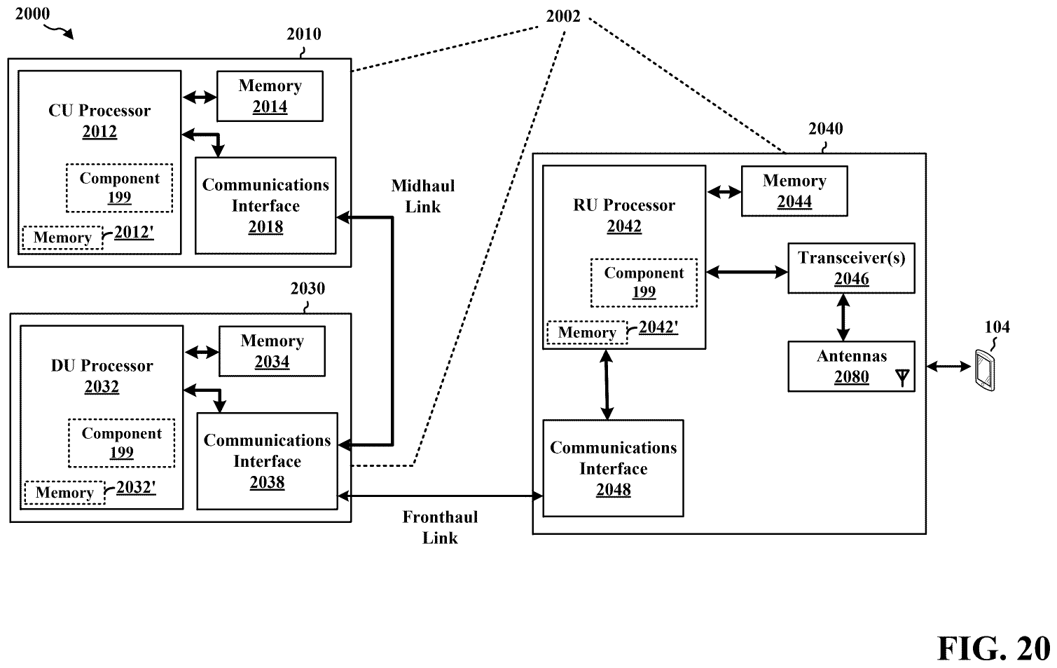

At 1802, the base station may transmit a configuration for a set of positioning measurements to a UE, where the configuration includes at least one configuration ID associated with an ML data collection or an ML inference for a set of RSs, such as described in connection with FIG. 13. For example, at 1320, the base station 1304 may transmit a configuration 1306 for positioning measurements, where the configuration 1306 includes at least one configuration ID 1308 that is associated with an ML data collection/training/inference for a set of RSs 1310. The transmission of the configuration may be performed by, e.g., the configuration ID association component 199 and/or the transceiver(s) 2046 of the network entity 2002 in FIG. 20.

In one example, the at least one configuration ID is associated with one or more parameters of assistance data configured for a positioning session of the UE, and the assistance data includes at least one of PRS assistance data, positioning calculation assistance data, error event data, or a combination thereof.

In another example, the at least one configuration ID is associated with a frequency layer that is selected based on a capability of the UE.

In another example, the at least one configuration ID is associated with a first set of positioning parameters with a fixed value and a second set of positioning parameters with multiple values.

In another example, the at least one configuration ID is associated with an area ID.

In another example, the at least one configuration ID is associated with a specific positioning mechanism.

In another example, the set of RSs includes at least one PRS, at least one SSB, at least one CSI-RS, or a combination thereof.

At 1804, the base station may transmit an indication indicating that the set of RSs is for the ML data collection or for the ML inference, such as described in connection with FIG. 13. For example, at 1332, the base station 1304 may transmit an indication indicating that the set of RSs 1310 is for the ML data collection or for the ML inference. The transmission of the indication may be performed by, e.g., the configuration ID association component 199 and/or the transceiver(s) 2046 of the network entity 2002 in FIG. 20.

In one example, the indication further indicates a data collection type.

At 1806, the base station may transmit the set of RSs via one or more DL channels, where the set of positioning measurements is associated with the one or more DL channels, such as described in connection with FIG. 13. For example, at 1322, the base station 1304 may transmit the set of RSs 1310 to the UE 1302. The transmission of the set of RSs may be performed by, e.g., the configuration ID association component 199 and/or the transceiver(s) 2046 of the network entity 2002 in FIG. 20.

At 1808, the base station may transmit a priority indication for the ML data collection, where the at least one parameter for the ML data collection or the ML inference is received based on the priority indication, such as described in connection with FIG. 13. For example, at 1334, the base station 1304 may transmit a priority indication for the ML data collection to the UE 1302, where the at least one parameter for the ML data collection or the ML inference is received based on the priority indication. The transmission of the priority indication may be performed by, e.g., the configuration ID association component 199 and/or the transceiver(s) 2046 of the network entity 2002 in FIG. 20.

At 1810, the base station may receive at least one parameter for the ML data collection or the ML inference based on the at least one configuration ID, such as described in connection with FIG. 13. For example, at 1328 of FIG. 13, the base station 1304 may receive at least one parameter for the ML data collection or the ML inference based on the at least one configuration ID 1308 from the UE 1302. The reception of the at least one parameter for the ML data collection or the ML inference may be performed by, e.g., the configuration ID association component 199 and/or the transceiver(s) 2046 of the network entity 2002 in FIG. 20.

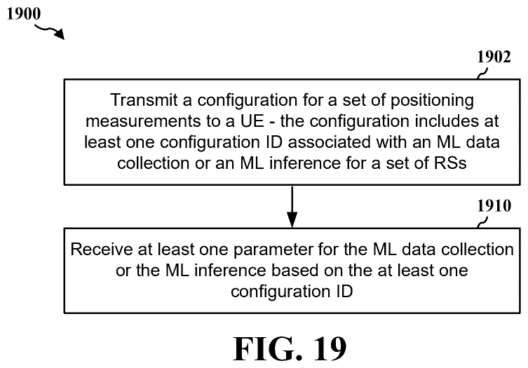

FIG. 19 is a flowchart 1900 of a method of wireless communication. The method may be performed by a base station (e.g., the base station 102, 1304, 1404; the network entity 2002. The method may enable the base station to associate positioning configurations and measurements with configuration ID to assist an ML model with ML training, inferencing, and/or refinement.

At 1902, the base station may transmit a configuration for a set of positioning measurements to a UE, where the configuration includes at least one configuration ID associated with an ML data collection or an ML inference for a set of RSs, such as described in connection with FIG. 13. For example, at 1320, the base station 1304 may transmit a configuration 1306 for positioning measurements, where the configuration 1306 includes at least one configuration ID 1308 that is associated with an ML data collection/training/inference for a set of RSs 1310. The transmission of the configuration may be performed by, e.g., the configuration ID association component 199 and/or the transceiver(s) 2046 of the network entity 2002 in FIG. 20.

In one example, the at least one configuration ID is associated with one or more parameters of assistance data configured for a positioning session of the UE, and the assistance data includes at least one of PRS assistance data, positioning calculation assistance data, error event data, or a combination thereof.

In another example, the at least one configuration ID is associated with a frequency layer that is selected based on a capability of the UE.

In another example, the at least one configuration ID is associated with a first set of positioning parameters with a fixed value and a second set of positioning parameters with multiple values.

In another example, the at least one configuration ID is associated with an area ID.

In another example, the at least one configuration ID is associated with a specific positioning mechanism.

In another example, the set of RSs includes at least one PRS, at least one SSB, at least one CSI-RS, or a combination thereof.

In another example, the base station may transmit an indication indicating that the set of RSs is for the ML data collection or for the ML inference, such as described in connection with FIG. 13. For example, at 1332, the base station 1304 may transmit an indication indicating that the set of RSs 1310 is for the ML data collection or for the ML inference. The transmission of the indication may be performed by, e.g., the configuration ID association component 199 and/or the transceiver(s) 2046 of the network entity 2002 in FIG. 20.

In another example, the indication further indicates a data collection type.

In another example, the base station may transmit the set of RSs via one or more DL channels, where the set of positioning measurements is associated with the one or more DL channels, such as described in connection with FIG. 13. For example, at 1322, the base station 1304 may transmit the set of RSs 1310 to the UE 1302. The transmission of the set of RSs may be performed by, e.g., the configuration ID association component 199 and/or the transceiver(s) 2046 of the network entity 2002 in FIG. 20.

In another example, the base station may transmit a priority indication for the ML data collection, where the at least one parameter for the ML data collection or the ML inference is received based on the priority indication, such as described in connection with FIG. 13. For example, at 1334, the base station 1304 may transmit a priority indication for the ML data collection to the UE 1302, where the at least one parameter for the ML data collection or the ML inference is received based on the priority indication. The transmission of the priority indication may be performed by, e.g., the configuration ID association component 199 and/or the transceiver(s) 2046 of the network entity 2002 in FIG. 20.

At 1910, the base station may receive at least one parameter for the ML data collection or the ML inference based on the at least one configuration ID, such as described in connection with FIG. 13. For example, at 1328 of FIG. 13, the base station 1304 may receive at least one parameter for the ML data collection or the ML inference based on the at least one configuration ID 1308 from the UE 1302. The reception of the at least one parameter for the ML data collection or the ML inference may be performed by, e.g., the configuration ID association component 199 and/or the transceiver(s) 2046 of the network entity 2002 in FIG. 20.

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the configuration ID association component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the configuration ID association component 199 may be configured to transmit a configuration for a set of positioning measurements to a UE, where the configuration includes at least one configuration ID associated with an ML data collection or an ML inference for a set of RSs. The configuration ID association component 199 may also be configured to receive at least one parameter for the ML data collection or the ML inference based on the at least one configuration ID. The configuration ID association component 199 may be within one or more processors of one or more of the CU 2010, DU 2030, and the RU 2040. The configuration ID association component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. In one configuration, the network entity 2002 may include means for transmitting a configuration for a set of positioning measurements to a UE, where the configuration includes at least one configuration ID associated with an ML data collection or an ML inference for a set of RSs. The network entity 2002 may further include means for receiving at least one parameter for the ML data collection or the ML inference based on the at least one configuration ID.

In one configuration, the network entity 2002 may further include means for transmitting the set of RSs via one or more DL channels, where the set of positioning measurements is associated with the one or more DL channels.

In another configuration, the network entity 2002 may further include means for transmitting a priority indication for the ML data collection, where the at least one parameter for the ML data collection or the ML inference is received based on the priority indication.

In another configuration, the network entity 2002 may further include means for transmitting an indication indicating that the set of RSs is for the ML data collection or for the ML inference. In such a configuration, the indication further indicates a data collection type.

In another configuration, the at least one configuration ID is associated with one or more parameters of assistance data configured for a positioning session of the UE, and the assistance data includes at least one of PRS assistance data, positioning calculation assistance data, error event data, or a combination thereof.

In another configuration, the at least one configuration ID is associated with a frequency layer that is selected based on a capability of the UE.

In another configuration, the at least one configuration ID is associated with a first set of positioning parameters with a fixed value and a second set of positioning parameters with multiple values.

In another configuration, the at least one configuration ID is associated with an area ID.

In another configuration, the at least one configuration ID is associated with a specific positioning mechanism.

In another configuration, the set of RSs includes at least one PRS, at least one SSB, at least one CSI-RS, or a combination thereof.

The means may be the configuration ID association component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

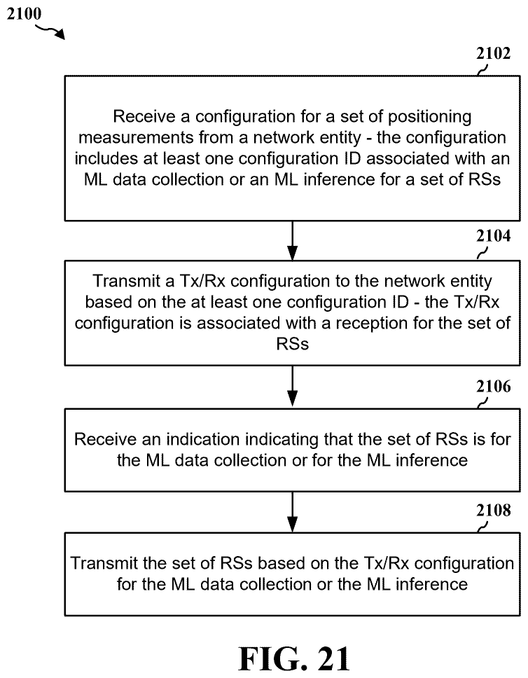

FIG. 21 is a flowchart 2100 of a method of wireless communication. The method may be performed by a UE (e.g., the UE 104, 404, 1302, 1402; the apparatus 2304). The method may enable the UE to associate positioning configurations and measurements with configuration ID to assist an ML model with ML training, inferencing, and/or refinement.

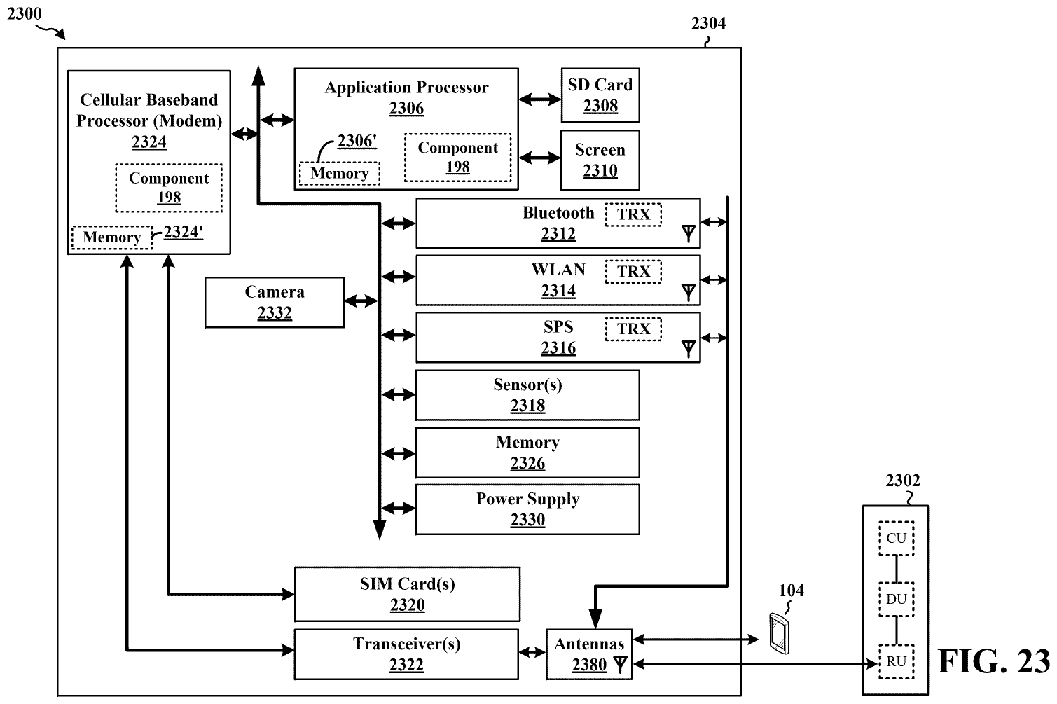

At 2102, the UE may receive a configuration for a set of positioning measurements from a network entity, where the configuration includes at least one configuration ID associated with an ML data collection or an ML inference for a set of RSs, such as described in connection with FIG. 14. For example, at 1420, the UE 1302 may receive a configuration 1406 for positioning measurements from the base station 1404, where the configuration 1406 includes at least one configuration ID 1408 that is associated with an ML data collection/training/inference for a set of RSs 1410. The reception of the configuration may be performed by, e.g., the configuration ID association component 198, the cellular baseband processor 2324, and/or the transceiver(s) 2322 of the apparatus 2304 in FIG. 23.

In one example, the configuration applies to a plurality of UEs.

In another example, the configuration is associated with a specific resource allocation.

In another example, the configuration is received via RRC messaging.

In another example, the at least one configuration ID is associated with one or more parameters of assistance data configured for a positioning session of the UE, and the assistance data includes at least one of PRS assistance data, positioning calculation assistance data, error event data, or a combination thereof.

In another example, the at least one configuration ID is associated with a frequency layer that is selected based on a capability of the UE.

In another example, the at least one configuration ID is associated with a first set of positioning parameters with a fixed value and a second set of positioning parameters with multiple values.

In another example, the at least one configuration ID is associated with an area ID.

In another example, the at least one configuration ID is associated with a specific positioning mechanism.

In another example, the set of RSs includes at least one SRS.

At 2104, the UE may transmit a Tx/Rx configuration to the network entity based on the at least one configuration ID, where the Tx/Rx configuration is associated with a reception for the set of RSs, such as described in connection with FIG. 14. For example, at 1424, the UE 1302 may a Tx/Rx configuration 1412 to the base station 1404 based on the at least one configuration ID 1408. The transmission of the Tx/Rx configuration may be performed by, e.g., the configuration ID association component 198, the cellular baseband processor 2324, and/or the transceiver(s) 2322 of the apparatus 2304 in FIG. 23.

In one example, the Tx/Rx configuration indicates: at least one antenna used by the UE for transmitting the set of RSs, the UE is transmitting the set of RSs based on TDM using at least two antennas, a beam forming strategy for transmitting the set of RSs, or a combination thereof.

At 2106, the UE may receive an indication indicating that the set of RSs is for the ML data collection or for the ML inference, such as described in connection with FIG. 14. For example, at 1432, the UE 1302 may receive an ML data collection indication from the base station 1404 indicating that the set of RSs 1410 is for the ML data collection or for the ML inference. The reception of the indication may be performed by, e.g., the configuration ID association component 198, the cellular baseband processor 2324, and/or the transceiver(s) 2322 of the apparatus 2304 in FIG. 23.

In one example, the indication further indicates a data collection type.

At 2108, the UE may transmit the set of RSs based on the Tx/Rx configuration for the ML data collection or the ML inference, such as described in connection with FIG. 14. For example, at 1436, the UE 1302 may transmit the set of RSs 1410 based on the Tx/Rx configuration 1412 for the ML data collection or the ML inference. The transmission of the set of RSs may be performed by, e.g., the configuration ID association component 198, the cellular baseband processor 2324, and/or the transceiver(s) 2322 of the apparatus 2304 in FIG. 23.

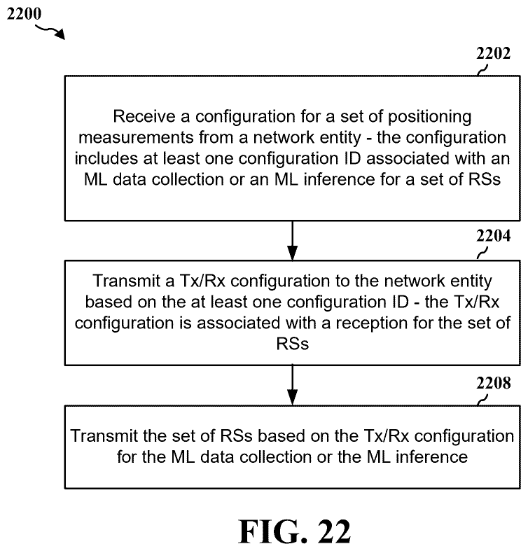

FIG. 22 is a flowchart 2200 of a method of wireless communication. The method may be performed by a UE (e.g., the UE 104, 404, 1302, 1402; the apparatus 2304). The method may enable the UE to associate positioning configurations and measurements with configuration ID to assist an ML model with ML training, inferencing, and/or refinement.

At 2202, the UE may receive a configuration for a set of positioning measurements from a network entity, where the configuration includes at least one configuration ID associated with an ML data collection or an ML inference for a set of RSs, such as described in connection with FIG. 14. For example, at 1420, the UE 1302 may receive a configuration 1406 for positioning measurements from the base station 1404, where the configuration 1406 includes at least one configuration ID 1408 that is associated with an ML data collection/training/inference for a set of RSs 1410. The reception of the configuration may be performed by, e.g., the configuration ID association component 198, the cellular baseband processor 2324, and/or the transceiver(s) 2322 of the apparatus 2304 in FIG. 23.

In one example, the configuration applies to a plurality of UEs.

In another example, the configuration is associated with a specific resource allocation.

In another example, the configuration is received via RRC messaging.

In another example, the at least one configuration ID is associated with one or more parameters of assistance data configured for a positioning session of the UE, and the assistance data includes at least one of PRS assistance data, positioning calculation assistance data, error event data, or a combination thereof.

In another example, the at least one configuration ID is associated with a frequency layer that is selected based on a capability of the UE.

In another example, the at least one configuration ID is associated with a first set of positioning parameters with a fixed value and a second set of positioning parameters with multiple values.

In another example, the at least one configuration ID is associated with an area ID.

In another example, the at least one configuration ID is associated with a specific positioning mechanism.

In another example, the set of RSs includes at least one SRS.

At 2204, the UE may transmit a Tx/Rx configuration to the network entity based on the at least one configuration ID, where the Tx/Rx configuration is associated with a reception for the set of RSs, such as described in connection with FIG. 14. For example, at 1424, the UE 1302 may a Tx/Rx configuration 1412 to the base station 1404 based on the at least one configuration ID 1408. The transmission of the Tx/Rx configuration may be performed by, e.g., the configuration ID association component 198, the cellular baseband processor 2324, and/or the transceiver(s) 2322 of the apparatus 2304 in FIG. 23.

In one example, the Tx/Rx configuration indicates: at least one antenna used by the UE for transmitting the set of RSs, the UE is transmitting the set of RSs based on TDM using at least two antennas, a beam forming strategy for transmitting the set of RSs, or a combination thereof.

In another example, the UE may receive an indication indicating that the set of RSs is for the ML data collection or for the ML inference, such as described in connection with FIG. 14. For example, at 1432, the UE 1302 may receive an ML data collection indication from the base station 1404 indicating that the set of RSs 1410 is for the ML data collection or for the ML inference. The reception of the indication may be performed by, e.g., the configuration ID association component 198, the cellular baseband processor 2324, and/or the transceiver(s) 2322 of the apparatus 2304 in FIG. 23. In such an example, the indication further indicates a data collection type.

At 2208, the UE may transmit the set of RSs based on the Tx/Rx configuration for the ML data collection or the ML inference, such as described in connection with FIG. 14. For example, at 1436, the UE 1302 may transmit the set of RSs 1410 based on the Tx/Rx configuration 1412 for the ML data collection or the ML inference. The transmission of the set of RSs may be performed by, e.g., the configuration ID association component 198, the cellular baseband processor 2324, and/or the transceiver(s) 2322 of the apparatus 2304 in FIG. 23.

FIG. 23 is a diagram 2300 illustrating an example of a hardware implementation for an apparatus 2304. The apparatus 2304 may be a UE, a component of a UE, or may implement UE functionality. In some aspects, the apparatus 2304 may include a cellular baseband processor 2324 (also referred to as a modem) coupled to one or more transceivers 2322 (e.g., cellular RF transceiver). The cellular baseband processor 2324 may include on-chip memory 2324′. In some aspects, the apparatus 2304 may further include one or more subscriber identity modules (SIM) cards 2320 and an application processor 2306 coupled to a secure digital (SD) card 2308 and a screen 2310. The application processor 2306 may include on-chip memory 2306′. In some aspects, the apparatus 2304 may further include a Bluetooth module 2312, a WLAN module 2314, an SPS module 2316 (e.g., GNSS module), one or more sensor modules 2318 (e.g., barometric pressure sensor/altimeter; motion sensor such as inertial management unit (IMU), gyroscope, and/or accelerometer(s), magnetometer, audio and/or other technologies used for positioning), additional memory modules 2326, a power supply 2330, and/or a camera 2332. The Bluetooth module 2312, the WLAN module 2314, and the SPS module 2316 may include an on-chip transceiver (TRX) (or in some cases, just a receiver (RX)). The Bluetooth module 2312, the WLAN module 2314, and the SPS module 2316 may include their own dedicated antennas and/or utilize the antennas 2380 for communication. The cellular baseband processor 2324 communicates through the transceiver(s) 2322 via one or more antennas 2380 with the UE 104 and/or with an RU associated with a network entity 2302. The cellular baseband processor 2324 and the application processor 2306 may each include a computer-readable medium/memory 2324′, 2306′, respectively. The additional memory modules 2326 may also be considered a computer-readable medium/memory. Each computer-readable medium/memory 2324′, 2306′, 2326 may be non-transitory. The cellular baseband processor 2324 and the application processor 2306 are each responsible for general processing, including the execution of software stored on the computer-readable medium/memory. The software, when executed by the cellular baseband processor 2324/application processor 2306, causes the cellular baseband processor 2324/application processor 2306 to perform the various functions described supra. The computer-readable medium/memory may also be used for storing data that is manipulated by the cellular baseband processor 2324/application processor 2306 when executing software. The cellular baseband processor 2324/application processor 2306 may be a component of the UE 350 and may include the memory 360 and/or at least one of the TX processor 368, the RX processor 356, and the controller/processor 359. In one configuration, the apparatus 2304 may be a processor chip (modem and/or application) and include just the cellular baseband processor 2324 and/or the application processor 2306, and in another configuration, the apparatus 2304 may be the entire UE (e.g., see 350 of FIG. 3) and include the additional modules of the apparatus 2304.

As discussed supra, the configuration ID association component 198 may be configured to receive a configuration for a set of positioning measurements from a network entity, where the configuration includes at least one configuration ID associated with an ML data collection or an ML inference for a set of RSs. The configuration ID association component 198 may also be configured to transmit a Tx/Rx configuration to the network entity based on the at least one configuration ID, where the Tx/Rx configuration is associated with a reception for the set of RSs. The configuration ID association component 198 may also be configured to transmit the set of RSs based on the Tx/Rx configuration for the ML data collection or the ML inference. The configuration ID association component 198 may be within the cellular baseband processor 2324, the application processor 2306, or both the cellular baseband processor 2324 and the application processor 2306. The configuration ID association component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2304 may include a variety of components configured for various functions. In one configuration, the apparatus 2304, and in particular the cellular baseband processor 2324 and/or the application processor 2306, may include means for receiving a configuration for a set of positioning measurements from a network entity, where the configuration includes at least one configuration ID associated with an ML data collection or an ML inference for a set of RSs. The apparatus 2304 may further include means for transmitting a Tx/Rx configuration to the network entity based on the at least one configuration ID, where the Tx/Rx configuration is associated with a reception for the set of RSs. The apparatus 2304 may further include means for transmitting the set of RSs based on the Tx/Rx configuration for the ML data collection or the ML inference.

In one configuration, the apparatus 2304 may further include means for receiving an indication indicating that the set of RSs is for the ML data collection or for the ML inference.

In one configuration, the Tx/Rx configuration indicates: at least one antenna used by the UE for transmitting the set of RSs, the UE is transmitting the set of RSs based on TDM using at least two antennas, a beam forming strategy for transmitting the set of RSs, or a combination thereof.

In another configuration, the configuration applies to a plurality of UEs.

In another configuration, the configuration is associated with a specific resource allocation.

In another configuration, the configuration is received via RRC messaging.

In another configuration, the at least one configuration ID is associated with one or more parameters of assistance data configured for a positioning session of the UE, and the assistance data includes at least one of PRS assistance data, positioning calculation assistance data, error event data, or a combination thereof.

In another configuration, the at least one configuration ID is associated with a frequency layer that is selected based on a capability of the UE.

In another configuration, the at least one configuration ID is associated with a first set of positioning parameters with a fixed value and a second set of positioning parameters with multiple values.

In another configuration, the at least one configuration ID is associated with an area ID.

In another configuration, the at least one configuration ID is associated with a specific positioning mechanism.

In another configuration, the set of RSs includes at least one SRS.

The means may be the configuration ID association component 198 of the apparatus 2304 configured to perform the functions recited by the means. As described supra, the apparatus 2304 may include the TX processor 368, the RX processor 356, and the controller/processor 359. As such, in one configuration, the means may be the TX processor 368, the RX processor 356, and/or the controller/processor 359 configured to perform the functions recited by the means.

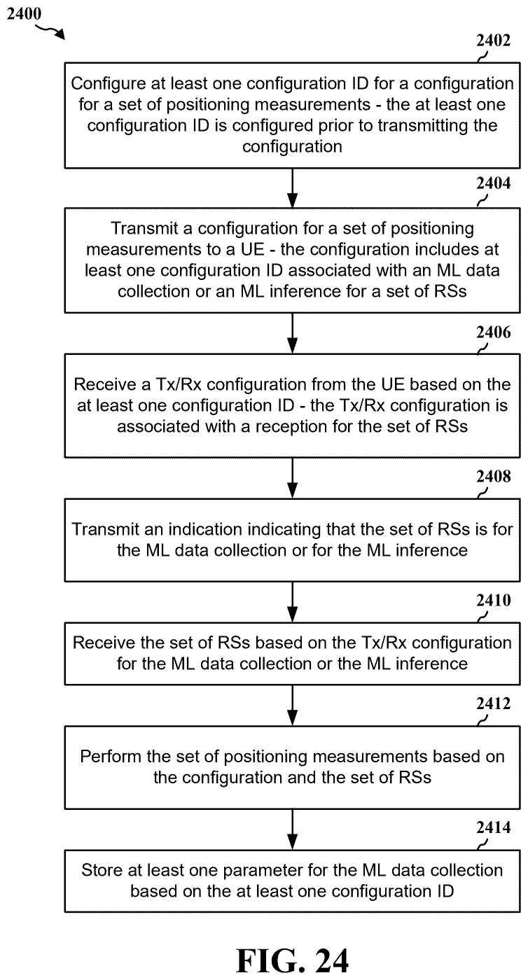

FIG. 24 is a flowchart 2400 of a method of wireless communication. The method may be performed by a base station (e.g., the base station 102, 1304, 1404; the network entity 2602. The method may enable the base station to associate positioning configurations and measurements with configuration ID to assist an ML model with ML training, inferencing, and/or refinement.

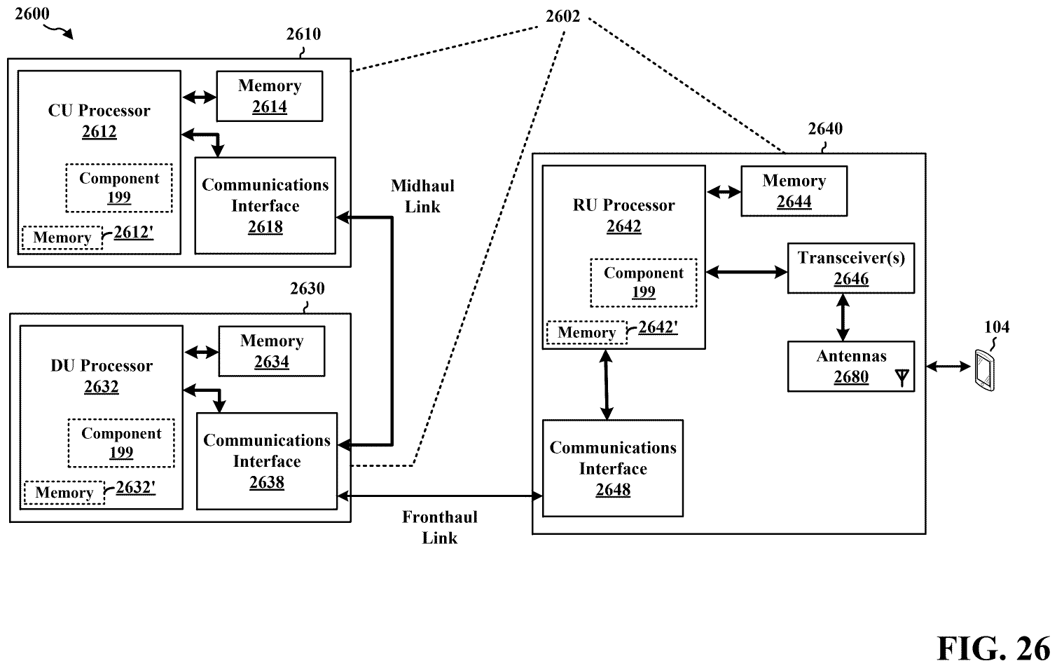

At 2402, the base station may configure at least one configuration ID for a configuration for a set of positioning measurements, where the at least one configuration ID is configured prior to transmitting the configuration, such as described in connection with FIG. 14. For example, at 1422, the base station 1404 may configure the at least one configuration ID 1408 for the configuration 1406 for positioning measurements. The configuration of the at least one configuration ID may be performed by, e.g., the configuration ID association component 199 and/or the transceiver(s) 2646 of the network entity 2602 in FIG. 26.

At 2404, the base station may transmit a configuration for a set of positioning measurements to a UE, where the configuration includes at least one configuration ID associated with an ML data collection or an ML inference for a set of RSs, such as described in connection with FIG. 14. For example, at 1420, the base station 1404 may transmit a configuration 1406 for positioning measurements, where the configuration 1406 includes at least one configuration ID 1408 that is associated with an ML data collection/training/inference for a set of RSs 1410. The transmission of the configuration may be performed by, e.g., the configuration ID association component 199 and/or the transceiver(s) 2646 of the network entity 2602 in FIG. 26.

In one example, the configuration applies to a plurality of UEs including the UE.

In another example, the configuration is associated with a specific resource allocation.

In another example, the configuration is transmitted via RRC messaging.

In another example, the Tx/Rx configuration indicates: at least one antenna used by the UE for transmitting the set of RSs, the UE is transmitting the set of RSs based on TDM using at least two antennas, a beam forming strategy for transmitting the set of RSs, or a combination thereof.

In another example, the at least one configuration ID is associated with a frequency layer that is selected based on a capability of the UE.

In another example, the at least one configuration ID is associated with a first set of positioning parameters with a fixed value and a second set of positioning parameters with multiple values.

In another example, the at least one configuration ID is associated with an area ID.

In another example, the at least one configuration ID is associated with a specific positioning mechanism.

In another example, the set of RSs includes at least one SRS.

At 2406, the base station may receive a Tx/Rx configuration from the UE based on the at least one configuration ID, where the Tx/Rx configuration is associated with a reception for the set of RSs, such as described in connection with FIG. 14. For example, at 1424, the base station 1404 may receive a Tx/Rx configuration 1412 from the UE 1402 based on the at least one configuration ID 1408. The reception of the Tx/Rx configuration may be performed by, e.g., the configuration ID association component 199 and/or the transceiver(s) 2646 of the network entity 2602 in FIG. 26.

At 2408, the base station may transmit an indication indicating that the set of RSs is for the ML data collection or for the ML inference, such as described in connection with FIG. 14. For example, at 1432, the base station 1404 may transmit an indication to the UE 1402 indicating that the set of RSs 1410 is for the ML data collection or for the ML inference. The transmission of the indication may be performed by, e.g., the configuration ID association component 199 and/or the transceiver(s) 2646 of the network entity 2602 in FIG. 26. In such an example, the indication further indicates a data collection type.

At 2410, the base station may receive the set of RSs based on the Tx/Rx configuration for the ML data collection or the ML inference, such as described in connection with FIG. 14. For example, at 1436, the base station 1404 may receive the set of RSs 1410 based on the Tx/Rx configuration 1412 for the ML data collection or the ML inference. The reception of the set of RSs may be performed by, e.g., the configuration ID association component 199 and/or the transceiver(s) 2646 of the network entity 2602 in FIG. 26.

At 2412, the base station may perform the set of positioning measurements based on the configuration and the set of RSs, such as described in connection with FIG. 14. For example, at 1438, the base station 1404 may perform positioning measurements based on the configuration 1406 and the set of RSs 1410. The positioning measurements may be performed by, e.g., the configuration ID association component 199 and/or the transceiver(s) 2646 of the network entity 2602 in FIG. 26.

At 2414, the base station may store at least one parameter for the ML data collection based on the at least one configuration ID, such as described in connection with FIG. 14. For example, at 1440, the base station 1404 may store at least one parameter for the ML data collection based on the at least one configuration ID 1408. The transmission of the configuration may be performed by, e.g., the configuration ID association component 199 and/or the transceiver(s) 2646 of the network entity 2602 in FIG. 26.

In one example, the base station may perform the ML data collection based on the at least one parameter.

In another example, the base station may transmit the at least one parameter for a ML training procedure.

In another example, the base station may load a NN based on the at least one configuration ID. In such an example, the base station may perform the ML inference for the set of positioning measurements via the NN.

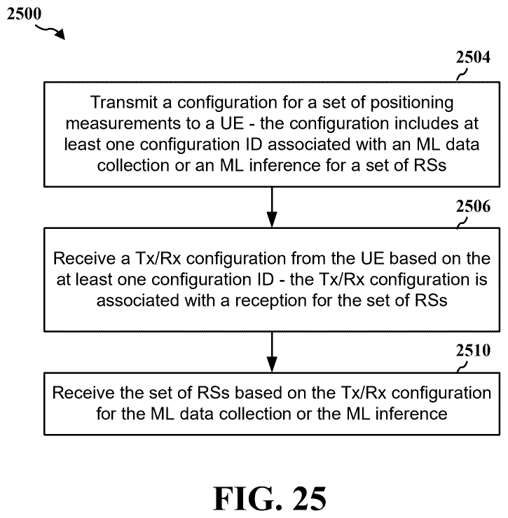

FIG. 25 is a flowchart 2500 of a method of wireless communication. The method may be performed by a base station (e.g., the base station 102, 1304, 1404; the network entity 2602. The method may enable the base station to associate positioning configurations and measurements with configuration ID to assist an ML model with ML training, inferencing, and/or refinement.

At 2504, the base station may transmit a configuration for a set of positioning measurements to a UE, where the configuration includes at least one configuration ID associated with an ML data collection or an ML inference for a set of RSs, such as described in connection with FIG. 14. For example, at 1420, the base station 1404 may transmit a configuration 1406 for positioning measurements, where the configuration 1406 includes at least one configuration ID 1408 that is associated with an ML data collection/training/inference for a set of RSs 1410. The transmission of the configuration may be performed by, e.g., the configuration ID association component 199 and/or the transceiver(s) 2646 of the network entity 2602 in FIG. 26.

In one example, the base station may configure at least one configuration ID for a configuration for a set of positioning measurements, where the at least one configuration ID is configured prior to transmitting the configuration, such as described in connection with FIG. 14. For example, at 1422, the base station 1404 may configure the at least one configuration ID 1408 for the configuration 1406 for positioning measurements. The configuration of the at least one configuration ID may be performed by, e.g., the configuration ID association component 199 and/or the transceiver(s) 2646 of the network entity 2602 in FIG. 26.

In another example, the configuration applies to a plurality of UEs including the UE.

In another example, the configuration is associated with a specific resource allocation.

In another example, the configuration is transmitted via RRC messaging.

In another example, the Tx/Rx configuration indicates: at least one antenna used by the UE for transmitting the set of RSs, the UE is transmitting the set of RSs based on TDM using at least two antennas, a beam forming strategy for transmitting the set of RSs, or a combination thereof.

In another example, the at least one configuration ID is associated with a frequency layer that is selected based on a capability of the UE.

In another example, the at least one configuration ID is associated with a first set of positioning parameters with a fixed value and a second set of positioning parameters with multiple values.

In another example, the at least one configuration ID is associated with an area ID.

In another example, the at least one configuration ID is associated with a specific positioning mechanism.

In another example, the set of RSs includes at least one SRS.

At 2506, the base station may receive a Tx/Rx configuration from the UE based on the at least one configuration ID, where the Tx/Rx configuration is associated with a reception for the set of RSs, such as described in connection with FIG. 14. For example, at 1424, the base station 1404 may receive a Tx/Rx configuration 1412 from the UE 1402 based on the at least one configuration ID 1408. The reception of the Tx/Rx configuration may be performed by, e.g., the configuration ID association component 199 and/or the transceiver(s) 2646 of the network entity 2602 in FIG. 26.

In one example, the base station may transmit an indication indicating that the set of RSs is for the ML data collection or for the ML inference, such as described in connection with FIG. 14. For example, at 1432, the base station 1404 may transmit an indication to the UE 1402 indicating that the set of RSs 1410 is for the ML data collection or for the ML inference. The transmission of the indication may be performed by, e.g., the configuration ID association component 199 and/or the transceiver(s) 2646 of the network entity 2602 in FIG. 26. In such an example, the indication further indicates a data collection type.

At 2510, the base station may receive the set of RSs based on the Tx/Rx configuration for the ML data collection or the ML inference, such as described in connection with FIG. 14. For example, at 1436, the base station 1404 may receive the set of RSs 1410 based on the Tx/Rx configuration 1412 for the ML data collection or the ML inference. The reception of the set of RSs may be performed by, e.g., the configuration ID association component 199 and/or the transceiver(s) 2646 of the network entity 2602 in FIG. 26.

In one example, the base station may perform the set of positioning measurements based on the configuration and the set of RSs, such as described in connection with FIG. 14. For example, at 1438, the base station 1404 may perform positioning measurements based on the configuration 1406 and the set of RSs 1410. The positioning measurements may be performed by, e.g., the configuration ID association component 199 and/or the transceiver(s) 2646 of the network entity 2602 in FIG. 26.

In another example, the base station may store at least one parameter for the ML data collection based on the at least one configuration ID, such as described in connection with FIG. 14. For example, at 1440, the base station 1404 may store at least one parameter for the ML data collection based on the at least one configuration ID 1408. The transmission of the configuration may be performed by, e.g., the configuration ID association component 199 and/or the transceiver(s) 2646 of the network entity 2602 in FIG. 26.

In another example, the base station may perform the ML data collection based on the at least one parameter.

In another example, the base station may transmit the at least one parameter for a ML training procedure.

In another example, the base station may load a NN based on the at least one configuration ID. In such an example, the base station may perform the ML inference for the set of positioning measurements via the NN.

FIG. 26 is a diagram 2600 illustrating an example of a hardware implementation for a network entity 2602. The network entity 2602 may be a BS, a component of a BS, or may implement BS functionality. The network entity 2602 may include at least one of a CU 2610, a DU 2630, or an RU 2640. For example, depending on the layer functionality handled by the configuration ID association component 199, the network entity 2602 may include the CU 2610; both the CU 2610 and the DU 2630; each of the CU 2610, the DU 2630, and the RU 2640; the DU 2630; both the DU 2630 and the RU 2640; or the RU 2640. The CU 2610 may include a CU processor 2612. The CU processor 2612 may include on-chip memory 2612′. In some aspects, the CU 2610 may further include additional memory modules 2614 and a communications interface 2618. The CU 2610 communicates with the DU 2630 through a midhaul link, such as an F1 interface. The DU 2630 may include a DU processor 2632. The DU processor 2632 may include on-chip memory 2632′. In some aspects, the DU 2630 may further include additional memory modules 2634 and a communications interface 2638. The DU 2630 communicates with the RU 2640 through a fronthaul link. The RU 2640 may include an RU processor 2642. The RU processor 2642 may include on-chip memory 2642′. In some aspects, the RU 2640 may further include additional memory modules 2644, one or more transceivers 2646, antennas 2680, and a communications interface 2648. The RU 2640 communicates with the UE 104. The on-chip memory 2612′, 2632′, 2642′ and the additional memory modules 2614, 2634, 2644 may each be considered a computer-readable medium/memory. Each computer-readable medium/memory may be non-transitory. Each of the processors 2612, 2632, 2642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the configuration ID association component 199 may be configured to transmit a configuration for a set of positioning measurements to a UE, where the configuration includes at least one configuration ID associated with an ML data collection or an ML inference for a set of RSs. The configuration ID association component 199 may also be configured to receive a Tx/Rx configuration from the UE based on the at least one configuration ID, where the Tx/Rx configuration is associated with a reception for the set of RSs. The configuration ID association component 199 may also be configured to receive the set of RSs based on the Tx/Rx configuration for the ML data collection or the ML inference. The configuration ID association component 199 may be within one or more processors of one or more of the CU 2610, DU 2630, and the RU 2640. The configuration ID association component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2602 may include a variety of components configured for various functions. In one configuration, the network entity 2602 may include means for transmitting a configuration for a set of positioning measurements to a UE, where the configuration includes at least one configuration ID associated with ML data collection or ML inference for a set of RSs. The network entity 2602 may further include means for receiving a Tx/Rx configuration from the UE based on the at least one configuration ID, where the Tx/Rx configuration is associated with a reception for the set of RSs. The network entity 2602 may further include means for receiving the set of RSs based on the Tx/Rx configuration for the ML data collection or the ML inference.

In one configuration, the network entity 2602 may further include means for configuring the at least one configuration ID for the configuration for the set of positioning measurements, where the at least one configuration ID is configured prior to transmitting the configuration.

In another configuration, the network entity 2602 may further include means for performing the set of positioning measurements based on the configuration and the set of RSs.

In another configuration, the network entity 2602 may further include means for storing at least one parameter for the ML data collection based on the at least one configuration ID.

In another configuration, the network entity 2602 may further include means for performing the ML data collection based on the at least one parameter.

In another configuration, the network entity 2602 may further include means for transmitting the at least one parameter for a ML training procedure.

In another configuration, the network entity 2602 may further include means for loading a NN based on the at least one configuration ID.

In another configuration, the network entity 2602 may further include means for performing the ML inference for the set of positioning measurements via the NN.

In another configuration, the configuration applies to a plurality of UEs including the UE.

In another configuration, the configuration is associated with a specific resource allocation.

In another configuration, the configuration is transmitted via RRC messaging.

In another configuration, the Tx/Rx configuration indicates: at least one antenna used by the UE for transmitting the set of RSs, the UE is transmitting the set of RSs based on TDM using at least two antennas, a beam forming strategy for transmitting the set of RSs, or a combination thereof.

In another configuration, the at least one configuration ID is associated with a frequency layer that is selected based on a capability of the UE.

In another configuration, the at least one configuration ID is associated with a first set of positioning parameters with a fixed value and a second set of positioning parameters with multiple values.

In another configuration, the at least one configuration ID is associated with an area ID.

In another configuration, the at least one configuration ID is associated with a specific positioning mechanism.

In another configuration, the set of RSs includes at least one SRS.

The means may be the configuration ID association component 199 of the network entity 2602 configured to perform the functions recited by the means. As described supra, the network entity 2602 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving a configuration for a set of positioning measurements from a network entity, where the configuration includes at least one configuration ID associated with an ML data collection or an ML inference for a set of RSs; performing the set of positioning measurements based on the configuration and the set of RSs; and storing at least one parameter for the ML data collection or load a first NN based on the at least one configuration ID.

Aspect 2 is the method of aspect 1, further including: receiving the set of RSs via one or more DL channels, where the set of positioning measurements is associated with the one or more DL channels.

Aspect 3 is the method of any of aspects 1 or 2, where the at least one processor is configured to store the at least one parameter for the ML data collection based on the at least one configuration ID.

Aspect 4 is the method of aspect 3, further including: performing the ML data collection based on the at least one parameter.

Aspect 5 is the method of aspect 3, further including: transmitting the at least one parameter for a ML training procedure.

Aspect 6 is the method of aspect 5, where the ML training procedure is associated with a second NN that is different from the first NN.

Aspect 7 is the method of aspect 3, further including: receiving a priority indication for the ML data collection; and determining whether to perform the ML data collection based on the priority indication.

Aspect 8 is the method of any of aspects 1 to 7, where the at least one processor is configured to load the first NN based on the at least one configuration ID.

Aspect 9 is the method of aspect 8, further including: performing the ML inference for the set of positioning measurements via the first NN.

Aspect 10 is the method of any of aspects 1 to 9, further including: receiving an indication indicating that the set of RSs is for the ML data collection or for the ML inference.

Aspect 11 is the method of aspect 10, where the indication further indicates a data collection type.

Aspect 12 is the method of any of aspects 1 to 11, where the at least one configuration ID is associated with one or more parameters of assistance data configured for a positioning session of the UE, and where the assistance data includes at least one of PRS assistance data, positioning calculation assistance data, error event data, or a combination thereof.

Aspect 13 is the method of any of aspects 1 to 12, where the at least one configuration ID is associated with a frequency layer that is selected based on a capability of the UE.

Aspect 14 is the method of any of aspects 1 to 13, where the at least one configuration ID is associated with a first set of positioning parameters with a fixed value and a second set of positioning parameters with multiple values.

Aspect 15 is the method of any of aspects 1 to 14, where the at least one configuration ID is associated with an area ID.

Aspect 16 is the method of any of aspects 1 to 15, where the at least one configuration ID is associated with a specific positioning mechanism.

Aspect 17 is the method of any of aspects 1 to 16, where the set of RSs includes at least one PRS, at least one SSB, at least one CSI-RS, or a combination thereof.

Aspect 18 is an apparatus for wireless communication at a UE, including: a memory; and at least one processor coupled to the memory and, based at least in part on information stored in the memory, the at least one processor is configured to implement any of aspects 1 to 17.

Aspect 19 is the apparatus of aspect 18, further including at least one of a transceiver or an antenna coupled to the at least one processor.

Aspect 20 is an apparatus for wireless communication including means for implementing any of aspects 1 to 17.

Aspect 21 is a computer-readable medium (e.g., a non-transitory computer-readable medium) storing computer executable code, where the code when executed by a processor causes the processor to implement any of aspects 1 to 17.

Aspect 22 is a method of wireless communication at a base station, including: transmitting a configuration for a set of positioning measurements to a UE, where the configuration includes at least one configuration ID associated with an ML data collection or an ML inference for a set of RSs; and receiving at least one parameter for the ML data collection or the ML inference based on the at least one configuration ID.

Aspect 23 is the method of aspect 22, further including: transmitting the set of RSs via one or more DL channels, where the set of positioning measurements is associated with the one or more DL channels.

Aspect 24 is the method of any of aspects 22 or 23, further including: transmitting a priority indication for the ML data collection, where the at least one parameter for the ML data collection or the ML inference is received based on the priority indication.

Aspect 25 is the method of any of aspects 22 to 24, further including: transmitting an indication indicating that the set of RSs is for the ML data collection or for the ML inference.

Aspect 26 is the method of aspect 25, where the indication further indicates a data collection type.

Aspect 27 is the method of any of aspects 22 to 26, where the at least one configuration ID is associated with one or more parameters of assistance data configured for a positioning session of the UE, and where the assistance data includes at least one of PRS assistance data, positioning calculation assistance data, error event data, or a combination thereof.

Aspect 28 is the method of any of aspects 22 to 27, where the at least one configuration ID is associated with a frequency layer that is selected based on a capability of the UE.

Aspect 29 is the method of any of aspects 22 to 28, where the at least one configuration ID is associated with a first set of positioning parameters with a fixed value and a second set of positioning parameters with multiple values.

Aspect 30 is the method of any of aspects 22 to 29, where the at least one configuration ID is associated with an area ID.

Aspect 31 is the method of any of aspects 22 to 30, where the at least one configuration ID is associated with a specific positioning mechanism.

Aspect 32 is the method of any of aspects 22 to 31, where the set of RSs includes at least one PRS, at least one SSB, at least one CSI-RS, or a combination thereof.

Aspect 33 is an apparatus for wireless communication at a base station, including: a memory; and at least one processor coupled to the memory and, based at least in part on information stored in the memory, the at least one processor is configured to implement any of aspects 22 to 32.

Aspect 34 is the apparatus of aspect 33, further including at least one of a transceiver or an antenna coupled to the at least one processor.

Aspect 35 is an apparatus for wireless communication including means for implementing any of aspects 22 to 32.

Aspect 36 is a computer-readable medium (e.g., a non-transitory computer-readable medium) storing computer executable code, where the code when executed by a processor causes the processor to implement any of aspects 22 to 32.

Aspect 37 is a method of wireless communication at a UE, including: receiving a configuration for a set of positioning measurements from a network entity, where the configuration includes at least one configuration ID associated with an ML data collection or an ML inference for a set of RSs; transmitting a Tx/Rx configuration to the network entity based on the at least one configuration ID, where the Tx/Rx configuration is associated with a reception for the set of RSs; and transmitting the set of RSs based on the Tx/Rx configuration for the ML data collection or the ML inference.

Aspect 38 is the method of aspect 37, where the configuration applies to a plurality of UEs.

Aspect 39 is the method of any of aspects 37 or 38, where the configuration is associated with a specific resource allocation.

Aspect 40 is the method of any of aspects 37 to 39, where the configuration is received via RRC messaging.

Aspect 41 is the method of any of aspects 37 to 40, where the Tx/Rx configuration indicates: at least one antenna used by the UE for transmitting the set of RSs, the UE is transmitting the set of RSs based on TDM using at least two antennas, a beam forming strategy for transmitting the set of RSs, or a combination thereof.

Aspect 42 is the method of any of aspects 37 to 41, further including: receiving an indication indicating that the set of RSs is for the ML data collection or for the ML inference.

Aspect 43 is the method of aspect 42, where the indication further indicates a data collection type.

Aspect 44 is the method of any of aspects 37 to 43, where the at least one configuration ID is associated with a frequency layer that is selected based on a capability of the UE.

Aspect 45 is the method of any of aspects 37 to 44, where the at least one configuration ID is associated with a first set of positioning parameters with a fixed value and a second set of positioning parameters with multiple values.

Aspect 46 is the method of any of aspects 37 to 45, where the at least one configuration ID is associated with an area ID.

Aspect 47 is the method of any of aspects 37 to 46, where the at least one configuration ID is associated with a specific positioning mechanism.

Aspect 48 is the method of any of aspects 37 to 47, The apparatus of claim 1, where the set of RSs includes at least one SRS.

Aspect 49 is an apparatus for wireless communication at a UE, including: a memory; and at least one processor coupled to the memory and, based at least in part on information stored in the memory, the at least one processor is configured to implement any of aspects 37 to 48.

Aspect 50 is the apparatus of aspect 49, further including at least one of a transceiver or an antenna coupled to the at least one processor.

Aspect 51 is an apparatus for wireless communication including means for implementing any of aspects 37 to 48.

Aspect 52 is a computer-readable medium (e.g., a non-transitory computer-readable medium) storing computer executable code, where the code when executed by a processor causes the processor to implement any of aspects 37 to 48.

Aspect 53 is a method of wireless communication at a base station, including: transmitting a configuration for a set of positioning measurements to a UE, where the configuration includes at least one configuration ID associated with an ML data collection or an ML inference for a set of RSs; receiving a Tx/Rx configuration from the UE based on the at least one configuration ID, where the Tx/Rx configuration is associated with a reception for the set of RSs; and receiving the set of RSs based on the Tx/Rx configuration for the ML data collection or the ML inference.

Aspect 54 is the method of aspect 53, further including: configuring the at least one configuration ID for the configuration for the set of positioning measurements, where the at least one configuration ID is configured prior to transmitting the configuration.

Aspect 55 is the method of any of aspects 53 or 54, further including: performing the set of positioning measurements based on the configuration and the set of RSs.

Aspect 56 is the method of aspect 55, further including: storing at least one parameter for the ML data collection based on the at least one configuration ID.

Aspect 57 is the method of aspect 56, further including: performing the ML data collection based on the at least one parameter.

Aspect 58 is the method of aspect 56, further including: transmitting the at least one parameter for a ML training procedure.

Aspect 59 is the method of any of aspects 53 to 58, where the at least one processor is configured to load a NN based on the at least one configuration ID.

Aspect 60 is the method of aspect 59, further including: perform the ML inference for the set of positioning measurements via the NN.

Aspect 61 is the method of any of aspects 53 to 60, where the configuration applies to a plurality of UEs including the UE.

Aspect 62 is the method of any of aspects 53 to 61, where the configuration is associated with a specific resource allocation.

Aspect 63 is the method of any of aspects 53 to 62, where the configuration is transmitted via RRC messaging.

Aspect 64 is the method of any of aspects 53 to 63, where the Tx/Rx configuration indicates: at least one antenna used by the UE for transmitting the set of RSs, the UE is transmitting the set of RSs based on TDM using at least two antennas, a beam forming strategy for transmitting the set of RSs, or a combination thereof.

Aspect 65 is the method of any of aspects 53 to 64, further including: transmit an indication indicating that the set of RSs is for the ML data collection or for the ML inference.

Aspect 66 is the method of aspect 65, where the indication further indicates a data collection type.

Aspect 67 is the method of any of aspects 53 to 66, where the at least one configuration ID is associated with a frequency layer that is selected based on a capability of the UE.

Aspect 68 is the method of any of aspects 53 to 67, where the at least one configuration ID is associated with a first set of positioning parameters with a fixed value and a second set of positioning parameters with multiple values.

Aspect 69 is the method of any of aspects 53 to 68, where the at least one configuration ID is associated with an area ID.

Aspect 70 is the method of any of aspects 53 to 69, where the at least one configuration ID is associated with a specific positioning mechanism.

Aspect 71 is the method of any of aspects 53 to 70, where the set of RSs includes at least one SRS.

Aspect 72 is an apparatus for wireless communication at a UE, including: a memory; and at least one processor coupled to the memory and, based at least in part on information stored in the memory, the at least one processor is configured to implement any of aspects 53 to 71.

Aspect 73 is the apparatus of aspect 72, further including at least one of a transceiver or an antenna coupled to the at least one processor.

Aspect 74 is an apparatus for wireless communication including means for implementing any of aspects 53 to 71.

Aspect 75 is a computer-readable medium (e.g., a non-transitory computer-readable medium) storing computer executable code, where the code when executed by a processor causes the processor to implement any of aspects 53 to 71.

What is claimed is:

1. An apparatus for wireless communication at a user equipment (UE), comprising:
a memory; and
at least one processor coupled to the memory and, based at least in part on information stored in the memory, the at least one processor is configured to:
receive a configuration for a set of positioning measurements from a network entity, wherein the configuration includes at least one configuration identifier (ID) associated with a machine learning (ML) data collection or an ML inference for a set of reference signals (RSs);
perform the set of positioning measurements based on the configuration and the set of RSs; and
store at least one parameter for the ML data collection or load a first neural network (NN) based on the at least one configuration ID.

2. The apparatus of claim 1, wherein the at least one processor is configured to:
receive the set of RSs via one or more DL channels, wherein the set of positioning measurements is associated with the one or more DL channels.

3. The apparatus of claim 1, wherein the at least one processor is further configured to:
perform the ML data collection based on the at least one parameter; and
transmit the at least one parameter for a ML training procedure.

4. The apparatus of claim 3, wherein the ML training procedure is associated with a second NN that is different from the first NN.

5. The apparatus of claim 1, wherein the at least one processor is further configured to:
receive a priority indication for the ML data collection; and
determine whether to perform the ML data collection based on the priority indication.

6. The apparatus of claim 1, wherein the at least one processor is configured to load the first NN based on the at least one configuration ID.

7. The apparatus of claim 1, wherein the at least one processor is further configured to:
perform the ML inference for the set of positioning measurements via the first NN.

8. The apparatus of claim 1, wherein the at least one processor is further configured to:
receive an indication indicating that the set of RSs is for the ML data collection or for the ML inference, wherein the indication further indicates a data collection type.

9. The apparatus of claim 1, wherein the at least one configuration ID is associated with one or more parameters of assistance data configured for a positioning session of the UE, and wherein the assistance data includes at least one of positioning reference signal (PRS) assistance data, positioning calculation assistance data, error event data, or a combination thereof.

10. The apparatus of claim 1, wherein the at least one configuration ID is associated with at least one of:
a frequency layer that is selected based on a capability of the UE,
a first set of positioning parameters with a fixed value and a second set of positioning parameters with multiple values,
an area ID, or
a specific positioning mechanism.

11. The apparatus of claim 1, wherein the set of RSs includes at least one positioning reference signal (PRS), at least one synchronization signal block (SSB), at least one channel state information reference signal (CSI-RS), or a combination thereof.

12. A method of wireless communication at a user equipment (UE), comprising:
receiving a configuration for a set of positioning measurements from a network entity, wherein the configuration includes at least one configuration identifier (ID) associated with a machine learning (ML) data collection or an ML inference for a set of reference signals (RSs);
performing the set of positioning measurements based on the configuration and the set of RSs; and
storing at least one parameter for the ML data collection or load a first neural network (NN) based on the at least one configuration ID.

13. The method of claim 12, further comprising:
performing the ML data collection based on the at least one parameter; and
transmitting the at least one parameter for a ML training procedure.

14. The method of claim 12, further comprising:
receiving a priority indication for the ML data collection; and
determining whether to perform the ML data collection based on the priority indication.

15. The method of claim 12, further comprising:
performing the ML inference for the set of positioning measurements via the first NN.

16. An apparatus for wireless communication at a network entity, comprising:
a memory; and
at least one processor coupled to the memory and, based at least in part on information stored in the memory, the at least one processor is configured to:
transmit a configuration for a set of positioning measurements to a user equipment (UE), wherein the configuration includes at least one configuration identifier (ID) associated with a machine learning (ML) data collection or an ML inference for a set of reference signals (RSs);
receive a transmission (Tx) or reception (Rx) (Tx/Rx) configuration from the UE based on the at least one configuration ID, wherein the Tx/Rx configuration is associated with a reception for the set of RSs; and
receive the set of RSs based on the Tx/Rx configuration for the ML data collection or the ML inference.

17. The apparatus of claim 16, wherein the at least one processor is further configured to:
configure the at least one configuration ID for the configuration for the set of positioning measurements, wherein the at least one configuration ID is configured prior to transmitting the configuration.

18. The apparatus of claim 16, wherein the at least one processor is further configured to:
perform the set of positioning measurements based on the configuration and the set of RSs.

19. The apparatus of claim 18, wherein the at least one processor is further configured to:
store at least one parameter for the ML data collection based on the at least one configuration ID.

20. The apparatus of claim 19, wherein the at least one processor is further configured to:
perform the ML data collection based on the at least one parameter.

21. The apparatus of claim 19, wherein the at least one processor is further configured to:
transmit the at least one parameter for a ML training procedure.

22. The apparatus of claim 16, wherein the at least one processor is configured to load a neural network (NN) based on the at least one configuration ID.

23. The apparatus of claim 22, wherein the at least one processor is further configured to:
perform the ML inference for the set of positioning measurements via the NN.

24. The apparatus of claim 16, wherein the configuration applies to a plurality of UEs including the UE.

25. The apparatus of claim 16, wherein the configuration is associated with a specific resource allocation.

26. The apparatus of claim 16, wherein the configuration is transmitted via radio resource control (RRC) messaging.

27. The apparatus of claim 16, wherein the Tx/Rx configuration indicates:
at least one antenna used by the UE for transmitting the set of RSs,
the UE is transmitting the set of RSs based on time-division multiplexing (TDM) using at least two antennas,
a beam forming strategy for transmitting the set of RSs, or
a combination thereof.

28. The apparatus of claim 16, wherein the at least one processor is further configured to:
transmit an indication indicating that the set of RSs is for the ML data collection or for the ML inference.

29. The apparatus of claim 16, wherein the at least one configuration ID is associated with at least one of:
a frequency layer that is selected based on a capability of the UE,
a first set of positioning parameters with a fixed value and a second set of positioning parameters with multiple values,
an area ID, or
a specific positioning mechanism.

30. A method of wireless communication at a network entity, comprising:
transmitting a configuration for a set of positioning measurements to a user equipment (UE), wherein the configuration includes at least one configuration identifier (ID) associated with a machine learning (ML) data collection or an ML inference for a set of reference signals (RSs);
receiving a transmission (Tx) or reception (Rx) (Tx/Rx) configuration from the UE based on the at least one configuration ID, wherein the Tx/Rx configuration is associated with a reception for the set of RSs; and
receiving the set of RSs based on the Tx/Rx configuration for the ML data collection or the ML inference.
